(19) United States
(12) Patent Application Publication
(10) Pub. No.: US 2022/0181916 A1
(43) Pub. Date: Jun. 9, 2022

(54) Wireless-Power Transmitters With Antenna Elements Having Multiple Power-Transfer Points That Each Only Transfer Electromagnetic Energy Upon Coupling With A Wireless-Power Receiver, And Methods Of Use Thereof

(71) Applicant: Energous Corporation, San Jose, CA (US)

(72) Inventors: Kishore Ramachandramurthy, San Jose, CA (US); Yunhong Liu, San Jose, CA (US); Erik Heinke, San Jose, CA (US); Gabriel Joseph Cohn, Mill Valley, CA (US)

(21) Appl. No.: 17/544,779

(22) Filed: Dec. 7, 2021

Related U.S. Application Data
(60) Provisional application No. 63/123,452, filed on Dec. 9, 2020.

(51) Int. Cl. H02J 50/40; H02J 7/00; H02J 50/05; H02J 50/80

(52) U.S. Cl. CPC H02J 50/402; H02J 7/0044; H02J 7/0048; H02J 50/80; H02J 50/05

(57) ABSTRACT

A wireless-power transmitter including an antenna including a plurality of power-transfer points. The antenna is configured to operate in multiple modes. The multiple modes include a standby mode and a single receiver power-transfer mode. The standby mode provides a signal to the antenna at predetermined time intervals. The signal causes the antenna to transmit electromagnetic energy that is below a threshold amount, and produce an electric field that is substantially equally distributed at each of the power-transfer points. The single receiver power-transfer mode is activated upon a wireless power-receiver coupling with one of the plurality of power-transfer points such that (i) a portion of the electric field is greater at the one of the plurality of the power-transfer points than at any other of the power-transfer points, and (ii) electromagnetic energy is transferred from the antenna to the wireless power-receiver at the one of the plurality of the power-transfer points.

### RELATED APPLICATION

This application claims priority to U.S. Provisional Patent Application No. 63/123,452, filed Dec. 9, 2020, entitled “Wireless-Power Transmitters with Antenna Elements Having Multiple Power-Transfer Points That Each Only Transfer Electromagnetic Energy Upon Coupling with a Wireless-Power Receiver, and Methods of Use Thereof,” which is hereby incorporated by reference in its entirety.

### TECHNICAL FIELD

The present disclosure relates generally to systems for wireless-power transmission, and more particularly to wireless-power transmitters with antenna elements having multiple power-transfer points that each only transfer electromagnetic energy upon coupling with a wireless-power receiver, and methods of use thereof.

### BACKGROUND

Wireless charging systems for consumer devices typically require users to place devices at a specific position or orientation around the wireless power transmitter to be charged. When the device is moved from the specific position or orientation, charging of the device is interrupted or terminated. Additionally, many conventional systems radiate power along a length of an antenna element and not only at a specific point along the length of the antenna element. This can result in a lossy transmission of wireless power.

As such, it would be desirable to provide systems and methods for wirelessly transmitting and receiving power that address the above-mentioned drawbacks.

### SUMMARY

The wireless-power transmission system described herein makes it possible for a wireless-power transmitter to operate in multiple modes, such as a standby mode, a single receiver power-transfer mode, and/or a multi-receiver power-transfer mode. While in standby mode, the wireless-power transmitter does not transmit or transmits negligible amounts (e.g., less than 0.1 W/kg) of electromagnetic energy. The single receiver power-transfer mode of the wireless-power transmitter is activated upon a wireless power-receiver coupling with one of a plurality of power-transfer points of an antenna element of the wireless-power transmitter. Similarly, the multi-receiver power-transfer mode of the wireless-power transmitter is activated upon at least two wireless power-receivers coupling with respective power-transfer points of a plurality of power-transfer points of the antenna element of the wireless-power transmitter. When in either single receiver power-transfer mode or multi-receiver power-transfer mode, the antenna element of the wireless-power transmitter transfers electromagnetic energy to the respective wireless power-receiver at the one (or each of the respective power-transfer points for the multi-receiver power-transfer mode) of the plurality of the power-transfer points. In this way, for example, the wireless-power transmission system is able to wirelessly transfer power to receivers in a localized fashion, thereby ensuring a safe environment for user and/or any other foreign objects (e.g., living or non-living items, such as pets, keys, etc.).

The wireless-power transmission system described herein additionally makes it possible for a wireless-power receiver to effectively and efficiently receive wireless power regardless of its placement at one of a plurality of power-transfer points of an antenna element of a wireless-power transmitter. For example, in some embodiments, the wireless-power receiver includes a first antenna element coupled to a first planar surface of a first metal feed plate, and a second antenna element coupled to a second planar surface of a second metal feed plate. The first antenna element is configured to capacitively couple with a wireless-power transmitting antenna (e.g., a power-transfer point of the plurality of power-transfer points of the antenna element of the wireless-power transmitter) such that the wireless-power transmitting antenna transfers electromagnetic energy to the first antenna element at the power-transfer point. The first metal feed plate causes the electromagnetic energy to be received by the first antenna element in a direction perpendicular to the first planar surface of the first metal feed plate. Similarly, the second antenna element is configured to capacitively couple with the wireless-power transmitting antenna such that the wireless-power transmitting antenna transfers electromagnetic energy to the second antenna element, and the second metal feed plate causes the electromagnetic energy to be received by the second antenna element in a direction perpendicular to the second planar surface of the second metal feed plate. In this way, the wireless-power receiver is able to receive the electromagnetic energy at either the first or second antenna element and direct the electromagnetic energy (e.g., an E-field associated with transmitted EM energy transmitter by the wireless-power transmitter antenna) in an optimal direction (e.g., perpendicular to a respective planar surface of a respective metal feed plate) to ensure an efficient transfer of wireless power.

(A1) In accordance with some embodiments, a wireless-power transmitter includes an antenna element including a plurality of power-transfer points. The antenna element is configured to operate in multiple modes. The multiple modes include a standby mode and a single receiver power-transfer mode. In the standby mode, a signal is provided to the antenna element at a predetermined time interval. The signal causes the antenna element to transmit electromagnetic energy that is below a threshold amount and causing the antenna element to produce an electric field that is substantially equally distributed at each of the plurality of power-transfer points. The single receiver power-transfer mode is activated upon a respective wireless power-receiver coupling with the antenna element at one of the plurality of power-transfer points such that (i) a portion of the electric field is greater at the one of the plurality of the power-transfer points than at any other of the plurality power-transfer points, and (ii) electromagnetic energy is transferred from the antenna element to the respective wireless power-receiver at the one of the plurality of the power-transfer points.

(A2) In some embodiments of A1, the multiple modes further include a multi receiver power-transfer mode. The multi receiver power-transfer mode activated upon at least a first wireless power-receiver coupling with the antenna element at a first power-transfer point of the plurality of power-transfer points, and a second wireless power-receiver coupling with the antenna element at a second power-transfer point of the plurality of power-transfer points distinct from the power-transfer point. A first portion of the electric field is greater at the first power-transfer point of the plurality of power-transfer points than at any other vacant power-transfer point of the plurality power-transfer points, and electromagnetic energy is transferred from the antenna element to the first wireless power-receiver at the first power-transfer point of the plurality of power-transfer points. A second portion of the electric field is greater at the second power-transfer point of the plurality of power-transfer points than at any other vacant power-transfer point of the plurality power-transfer points, and electromagnetic energy is transferred from the antenna element to the second wireless power-receiver at the second power-transfer point of the plurality of power-transfer points. The first portion of the electric field and the second portion of the electric field are substantially similar.

(A3) In some embodiments of A2, the multi receiver power-transfer mode transfers electromagnetic energy from the antenna element to the first wireless power-receiver and the second wireless power-receiver without using a power splitter.

(A4) In some embodiments of any one of A1-A3, the antenna element has a substantially symmetric design.

(A5) In some embodiments of any one of A1-A4, the antenna element has a star pattern with a plurality of sub-antenna elements on the edges of the antenna element.

(A6) In some embodiments of any one of A1-A5, the antenna element includes a plurality of sub-antenna elements, wherein each sub-antenna element includes a sleeve configured to impedance match with a wireless-power receiver.

(A7) In some embodiments of any one of A1-A6, the antenna element is surrounded by an E-wall that is configured to modulate the portion of the electric field at the one of the plurality of the power-transfer points

(A8) In some embodiments of any one of A1-A7, the antenna element is surrounded by an E-wall that provides an extended ground plane.

(A9) In some embodiments of any one of A1-A8, the antenna element is surrounded by an E-wall that is configured to maximize the power transfer to the one of the plurality of power-transfer points.

(A10) In some embodiments of any one of A1-A9, the antenna element is surrounded by an E-wall that is configured to direct the portion of the electric field vertically from the antenna element.

(A11) In some embodiments of any one of A1-A10, the antenna element is surrounded by an E-wall, and the antenna element and the E-wall is sized such that it is configured to be placed within a housing including a cavity well and a cavity wall, wherein the plurality of power-transfer points is positioned at the cavity well, and the E-wall is positioned at the cavity wall.

(A12) In some embodiments of any one of A1-A11, the antenna element is a low gain antenna element configured to operate at a center frequency of approximately 900 MHz.

(A13) In some embodiments of any one of A1-A12, while the wireless-power transmitter is in the standby mode, the antenna element has a gain below 3 dBi when the signal is provided to the antenna element.

(A14) In some embodiments of any one of A1-A13, while the wireless-power transmitter is in the standby mode, the antenna element has a gain below 2 dBi when the signal is provided to the antenna element.

(A15) In some embodiments of any one of A1-A14, while the wireless-power transmitter is in the single receiver power-transfer mode, the antenna element has a gain of approximately 2 dBi and operates at a center frequency of approximately 900 MHz.

(A16) In some embodiments of any one of A1-A15, while the wireless-power transmitter is in the single receiver power-transfer mode, the antenna element couples with the respective wireless-power receiver at a coupling efficiency of at least 50% higher.

(A17) In some embodiments of any one of A1-16, while the wireless-power transmitter is in the multi receiver power-transfer mode, the antenna element has a gain of at least 2 dBi and operates at a center frequency of approximately 900 MHz.

(A18) In some embodiments of any one of A1-17, while the wireless-power transmitter is in the multi-receiver power-transfer mode, the antenna element couples with the first and second wireless-power receivers at a combined coupling efficiency of at least 50%.

(A19) In some embodiments of any one of A1-18, the coupling of the respective wireless power-receiver with the antenna element at the one of the plurality of power-transfer points is a capacitive coupling.

(A20) In some embodiments of any one of A1-19, further includes a controller configured to cause the antenna element to switch between the multiple modes.

(A21) In some embodiments of any one of A20, further includes a power amplifier coupled to the antenna element, and the controller is configured to cause the power amplifier to provide the signal to the antenna element.

(A22) In some embodiments of any one of A1-21, further includes a communications component, and the controller is configured to receive from the communications component charging configuration data for the respective wireless power-receiver that is used determine characteristics of the EM energy that is transferred to the respective wireless power-receiver.

(A23) The wireless-power transmitter of any of claims A1-A22, the respective wireless power-receiver is any wireless-power receiver of claims B1-B12 (described below).

(B1) In accordance with some embodiments, a wireless-power receiver includes a first antenna element coupled to a first planar surface of a first metal feed plate. The first antenna element is configured to capacitively couple with a wireless-power transmitting antenna such that the wireless-power transmitting antenna transfers electromagnetic energy to the first antenna element, and the first metal feed plate causes the electromagnetic energy to be received by the first antenna element in a direction perpendicular to the first planar surface of the first metal feed plate. The wireless-power receiver also includes a second antenna element coupled to a first planar surface of a second metal feed plate. The second antenna element is configured to capacitively couple with the wireless-power transmitting antenna such that the wireless-power transmitting antenna transfers electromagnetic energy to the second antenna element, and the second metal feed plate causes the electromagnetic energy to be received by the second antenna element in a direction perpendicular to the first planar surface of the second metal feed plate. The wireless-power receiver further includes power conversion circuitry coupled to a second planar surface of the first metal feed plate opposite the first planar surface, the power conversion circuitry being configured to receive the electromagnetic energy via the first metal feed plate of the first antenna element.

(B2) In some embodiments of B1, further includes additional power conversion circuitry coupled to a second planar surface of the second metal feed plate opposite the first planar surface, the additional power conversion circuitry being configured to receive the electromagnetic energy via the second metal feed plate of the second antenna element.

(B3) In some embodiments of any one of B1-B2, the power conversion circuitry and the additional power conversion circuitry are the same.

(B4) In some embodiments of any one of B1-B3, the first antenna element and the second antenna element are respective wires forming helical patterns.

(B5) In some embodiments of any one of B1-B4, the first antenna element is configured to couple with a first cap that encloses the first antenna element and the second antenna element is configured to couple with a second cap that encloses the second antenna element, wherein the first cap and the second cap operate as a dielectric.

(B6) In some embodiments of B5, the first cap and the second cap has a return loss of approximately 8 dB.

(B7) In some embodiments of any one of B5-B6, the first cap and the second cap include respective metal interiors.

(B8) In some embodiments of any one of B1-B7, the first antenna element is perpendicular to the first planar surface of the first metal feed plate and the second antenna element is perpendicular to the first planar surface of the second metal feed plate.

(B9) In some embodiments of any one of B1-B8, wireless-power receiver of any of claims 23-30, wherein the first antenna element and the second antenna element has a gain of approximately 2 dBi.

(B10) In some embodiments of any one of B1-B9, the power conversion circuitry is configured to convert the electromagnetic energy into electrical energy for charging a battery electrically couple to the wireless-power-receiver.

(B11) In some embodiments of any one of B1-B10, the wireless-power receiver configured to be placed in a housing including a first end and a second end opposite the first end. The first antenna element is positioned at the first end of the housing, and the second antenna element is positioned at the second end of the housing.

(B12) In some embodiments of any one of B11, the housing includes a body, and the power conversion circuitry is positioned within the body of the housing.

(B12) In some embodiments of any one of B1-B12, the wireless-power transmitting antenna is the antenna element of the wireless-power transmitter of claims A1-A22.

(C1) In accordance with some embodiments, a method of wirelessly providing power includes, at a wireless-power transmitter including an antenna element including a plurality of power-transfer points, the antenna element configured to operate in multiple modes, operating the antenna element in a standby mode of the multiple modes. Operating the antenna element in the standby mode includes providing to the antenna element a signal at a predetermined time interval, transmitting, by the antenna element, electromagnetic (EM) energy based on the signal that is below a threshold amount of EM energy, and generating, by the antenna element, an electric field based on the signal that is substantially equally distributed at each of the plurality of power-transfer points. The method includes detecting a first wireless-power receiver coupling with the antenna element at a first power-transfer point of the plurality of power-transfer points, and in response to the detecting, operating the antenna element in a single receiver power-transfer mode. Operating the antenna element in the single receiver power-transfer mode includes adjusting a portion of the electric field, generated by the antenna element, such that it is greater at the first power-transfer point of the plurality of power-transfer points than at any other of the plurality power-transfer points, and transferring EM energy from the antenna element to the first wireless power-receiver at the first power-transfer point of the plurality of power-transfer points.

(C2) In some embodiments of C1, while operating the antenna element in the single receiver power-transfer mode, the method includes detecting a second wireless-power receiver coupling with the antenna element at a second power-transfer point of the plurality of power-transfer points, the second power-transfer point being distinct from the first power-transfer point. In response to the detecting, the method includes operating the antenna element in a multi-receiver power-transfer mode, including adjusting another portion of the electric field, generated by the antenna element, such that it is greater at the second power-transfer point of the plurality of power-transfer points than at any other vacant plurality power-transfer points, transferring EM energy from the antenna element to the first wireless power-receiver at the first power-transfer point of the plurality of power-transfer points, and transferring EM energy from the antenna element to the second wireless power-receiver at the second power-transfer point of the plurality of power-transfer points. The portion of the electric field at the first power-transfer point and the other portion of the electric field at the second power-transfer point are substantially similar.

(C3) In some embodiments of C1, while operating the antenna element in the standby mode, the method includes detecting the first wireless-power receiver coupling with the antenna element at the first power-transfer point of the plurality of power-transfer points and a second wireless-power receiver coupling with the antenna element at a second power-transfer point of the plurality of power-transfer points, the second power-transfer point being distinct from the first power-transfer point. In response to the detecting, the method includes operating the antenna element in a multi-receiver power-transfer mode, including adjusting a first portion of the electric field, generated by the antenna element, such that it is greater at the first power-transfer point of the plurality of power-transfer points than at any other vacant plurality power-transfer points, and adjusting a second portion of the electric field, generated by the antenna element, such that it is greater at the second power-transfer point of the plurality of power-transfer points than at any other vacant plurality power-transfer points. The method further includes transferring EM energy from the antenna element to the first wireless power-receiver at the first power-transfer point of the plurality of power-transfer points and transferring EM energy from the antenna element to the second wireless power-receiver at the second power-transfer point of the plurality of power-transfer points. The first portion of the electric field at the first power-transfer point and the second portion of the electric field at the second power-transfer point are substantially similar.

(C4) In some embodiments of any of C1-C3, the wireless-power transmitter further includes an E-wall surrounding the antenna element. The E-wall being configured to modulate the portion of the electric field at the one of the plurality of the power-transfer points.

(C5) In some embodiments of C4, the E-wall provides an extended ground plane.

(C6) In some embodiments of any of C4-05, the E-wall is configured to maximize the power transfer to the one of the plurality of power-transfer points.

(C7) In some embodiments of any of C4-C6, the E-wall is configured to direct the portion of the electric field vertically from the antenna element.

(D1) In accordance with some embodiments, a method of manufacturing a wireless-power transmitter includes forming an antenna element including a plurality of power-transfer points. Forming the antenna element includes forming a plurality of sub-antenna elements. Each sub-antenna element has a same shape, each sub-antenna element extends from a center of the antenna element to the outer edges of the antenna element, and the plurality of sub-antenna elements form a symmetric antenna element. The antenna element is configured to operate in multiple modes including a standby mode and a single receiver power-transfer mode. While in the standby mode, a signal is provided to the antenna element at a predetermined time interval. The signal causes the antenna element to transmit electromagnetic energy that is below a threshold amount and causes the antenna element to produce an electric field that is substantially equally distributed at each of the plurality of power-transfer points. The single receiver power-transfer mode is activated upon a respective wireless power-receiver coupling with one of the plurality of power-transfer points. In the single receiver power-transfer mode, a portion of the electric field is greater at the one of the plurality of the power-transfer points than at any other of the plurality power-transfer points, and electromagnetic energy is transferred from the antenna element to the respective wireless power-receiver at the one of the plurality of the power-transfer points.

(D2) In some embodiments of D1, the method includes forming an E-wall surrounding the antenna element. The E-wall being configured to modulate the portion of the electric field at the one of the plurality of the power-transfer points.

(D3) In some embodiments of D2, the E-wall is configured to provide an extended ground plane.

(D4) In some embodiments of any of D2-D3, the E-wall is configured to maximize the power transfer to the one of the plurality of power-transfer points.

(D5) In some embodiments of any of D2-D4, the E-wall is configured to direct the portion of the electric field vertically from the antenna element.

(D6) In some embodiments of any of D2-D5, forming the E-wall includes sizing the E-wall such that it is configured to be placed within a housing including a cavity wall, and placing the E-wall adjacent to the cavity wall such that the E-wall is vertical with the cavity wall.

(D7) In some embodiments of any of D1-D6. forming the antenna element includes sizing the antenna element such that it is configured to be placed within a housing including a cavity well and placing the antennal element adjacent to the cavity well such that the plurality of power-transfer points is positioned at the cavity well.

(D8) In some embodiments of any of D1-D7, the method includes positioning the transmitter within a housing.

(E1) In accordance with some embodiments, a method of manufacturing a wireless-power receiver includes forming a first antenna element, providing a first metal plate including a first planar surface and a second planar surface, the first planar surface opposite the first planar surface, and coupling the first antenna element to the first planar surface of the first metal feed plate. The first antenna element is configured to capacitively couple with a wireless-power transmitting antenna such that the wireless-power transmitting antenna transfers electromagnetic energy to the first antenna element, and the first metal feed plate causes the electromagnetic energy to be received by the first antenna element in a direction perpendicular to the first planar surface of the first metal feed plate. The method further includes forming a second antenna element, providing a second metal plate distinct from the first metal plate, the second metal plate including a first planar surface and a second planar surface, the first planar surface opposite the first planar surface, and coupling the second antenna element to the first planar surface of the second metal feed plate. The second antenna element is configured to capacitively couple with a wireless-power transmitting antenna such that the wireless-power transmitting antenna transfers electromagnetic energy to the second antenna element, and the second metal feed plate causes the electromagnetic energy to be received by the second antenna element in a direction perpendicular to the first planar surface of the second metal feed plate. The method also includes providing power conversion circuitry, and coupling the power conversion circuitry to the second planar surface of the first metal feed plate. The power conversion circuitry being configured to receive the electromagnetic energy via the first metal feed plate of the first antenna element.

(E2) In some embodiments of E1, the method further includes providing additional power conversion circuitry, and coupling the additional power conversion circuitry to the second planar surface of the second metal feed plate. The power conversion circuitry being configured to receive the electromagnetic energy via the first metal feed plate of the second antenna element.

(E3) In some embodiments of E2, the power conversion circuitry and the additional power conversion circuitry are the same.

(E4) In some embodiments of any of E1-E3, first antenna element and the second antenna element are respective wires forming helical patterns.

(E5) In some embodiments of any of E1-E4, the method further includes providing a first cap, and coupling the first cap to the first antenna element such that the first cap encloses the first antenna element. The method further includes providing a second cap, and coupling the second cap to the second antenna element such that the second cap encloses the second antenna element. The first cap and the second cap operate as a dielectric.

(E6) In some embodiments of E5, the first and second metal cap include metallic interiors.

(E7) In some embodiments of any of E1-E6, the first antenna element is perpendicular to the first planar surface of the first metal feed plate and the second antenna element is perpendicular to the first planar surface of the second metal feed plate.

(E8) In some embodiments of any of E1-E7, the method further includes providing a battery, and coupling the battery to the power conversion circuitry. The power conversion circuitry being configured to convert the electromagnetic energy into electrical energy for charging the battery.

(E9) In some embodiments of any of E1-E8, the method further includes placing the wireless-power receiver within a housing including a first end and a second end opposite the first end. The method further includes positioning the first antenna element at the first end of the housing, and positioning the second antenna element at the second end of the housing.

(E10) In some embodiments of E9, the housing further includes a body, and placing the wireless-power receiver within housing further includes positioning the power conversion circuitry in the body of the housing.

Note that the various embodiments described above can be combined with any other embodiments described herein. The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

So that the present disclosure can be understood in greater detail, a more particular description may be had by reference to the features of various embodiments, some of which are illustrated in the appended drawings. The appended drawings, however, merely illustrate pertinent features of the present disclosure and are therefore not to be considered limiting, for the description may admit to other effective features.

FIG. 1 illustrates a wireless-power transmission system, in accordance with some embodiments.

FIGS. 2A and 2B illustrate the wireless-power transmitter and standby mode operation, in accordance with some embodiments.

FIG. 3 illustrates a wireless-power receiver, in accordance with some embodiments.

FIGS. 4A-4C illustrate performance of a wireless-power receiver without one or more caps, in accordance with some embodiments.

FIGS. 5A-5C illustrate performance of a wireless-power receiver with one or more caps including a metallic interior, in accordance with some embodiments.

FIGS. 6A-6C illustrate performance of a wireless-power receiver with one or more caps including a non-metallic interior, in accordance with some embodiments.

FIGS. 7A-7D illustrate the performance of a wireless-power transmitter capacitively coupled with a wireless-power receiver at different operational frequencies, in accordance with some embodiments.

FIGS. 8A-8D illustrate the performance of a wireless-power transmitter with an E-wall capacitively coupled with a wireless-power receiver at different operational frequencies, in accordance with some embodiments

FIGS. 9A and 9B illustrate the electric field produced at the transmitter antenna element without an E-wall, in accordance with some embodiments

FIGS. 10A and 10B illustrate the electric field produced at the transmitter antenna element with an E-wall, in accordance with some embodiments.

FIGS. 11A and 11B illustrate the performance of a wireless-power transmitter with an E-wall capacitively coupled with multiple wireless-power receivers at different operational frequencies, in accordance with some embodiments.

FIGS. 12A-12D illustrate the electric field of a wireless-power transmitter with an E-wall at the transmitter antenna element, in accordance with some embodiments.

FIGS. 13A and 13B are block diagrams of a wireless-power transmitter, in accordance with some embodiments.

FIG. 14 is a block diagram illustrating one or more components of a wireless power transmitter, in accordance with some embodiments.

FIG. 15 is a block diagram illustrating a wireless power receiver, in accordance with some embodiments.

FIGS. 16A and 16B are flow diagrams showing a method of transferring electromagnetic energy to one or more wireless-power receivers, in accordance with some embodiments.

FIGS. 17A and 17B are flow diagrams showing a method of forming a wireless-power transmitter, in accordance with some embodiments.

FIGS. 18A and 18B are flow diagrams showing a method of forming a wireless-power receiver, in accordance with some embodiments.

In accordance with common practice, the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### DETAILED DESCRIPTION

Numerous details are described herein in order to provide a thorough understanding of the example embodiments illustrated in the accompanying drawings. However, some embodiments may be practiced without many of the specific details, and the scope of the claims is only limited by those features and aspects specifically recited in the claims. Furthermore, well-known processes, components, and materials have not been described in exhaustive detail so as not to unnecessarily obscure pertinent aspects of the embodiments described herein.

The transmitter device can be an electronic device that includes, or is otherwise associated with, various components and circuits responsible for, e.g., generating and transmitting electromagnetic energy, forming transmission energy within a radiation profile at locations in a transmission field, monitoring the conditions of the transmission field, and adjusting the radiation profile where needed. The radiation profile described herein refers to a distribution of energy field within the transmission range of a transmitter device or an individual antenna (also referred to as a “transmitter”). A receiver (also referred to as a wireless-power receiver) can be an electronic device that comprises at least one antenna, at least one rectifying circuit, and at least one power converter, which may utilize energy transmitted in the transmission field from a transmitter for powering or charging the electronic device.

In some embodiments, the wireless-power transmitter device is a Near Field charging pad. In some embodiments, the Near Field charging pad, is configured to initiate wireless charging once a receiver and/or foreign object is in physical contact with the wireless-power transmitter device. In some embodiments, measurements of the antenna (e.g., when the antenna is unloaded/open, or with ideal coupling alignment) are obtained from factory manufacture tests, simulations, and/or characterization. In some embodiments, the Near Field charging pad is calibrated at a factory with the wireless-power transmission system and/or methods disclosed herein. In some embodiments, the wireless-power transmission system and/or methods are further calibrated to operate with one or more antennas installed in the Near Field charging pad. In other words, in some embodiments, the radiation profile, SAR values, data (e.g., impedance values) from one or more measurement points, operational scenarios for the Near Field charging pad, and/or other Near Field charging pad configurations are determined at a factory and stored in memory for use during operation. For example, nominal impedance within tolerances for the Near Field charging pad can be measured during factory calibration and stored. In some embodiments, during operation, a receiver in different positions and state of charge creates a measurable impedance displacement from the stored values. In some embodiments, the Near Field charging pad can perform bias correction and/or tuning to protect and optimize the system performance.

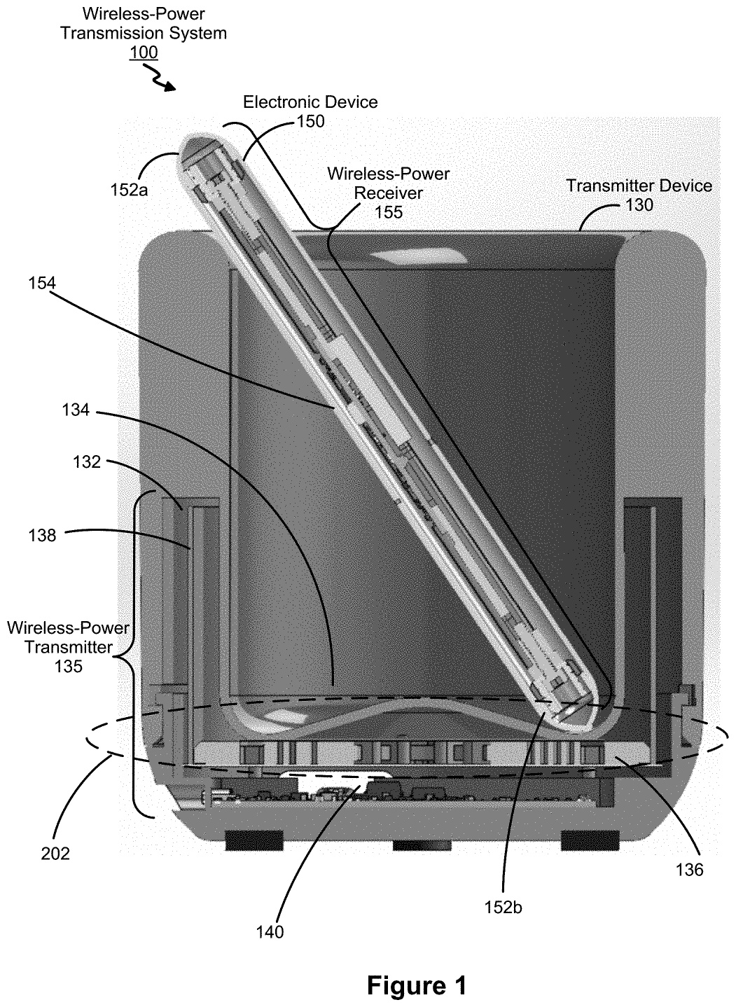

FIG. 1 illustrates a wireless-power transmission system 100, in accordance with some embodiments. The wireless-power transmission system 100 includes a transmitter device 130 and an electronic device 150. The transmitter device 130 includes or is coupled to a wireless-power transmitter 135, and the electronic device 150 includes or is coupled to a wireless-power receiver 155. The wireless-power transmitter 135 and the wireless-power receiver 155 are configured to electrically couple such that electromagnetic energy is transferred from the wireless-power transmitter 135 to the wireless-power receiver 155 as described below. In some embodiments, electrically coupling means capacitively coupling.

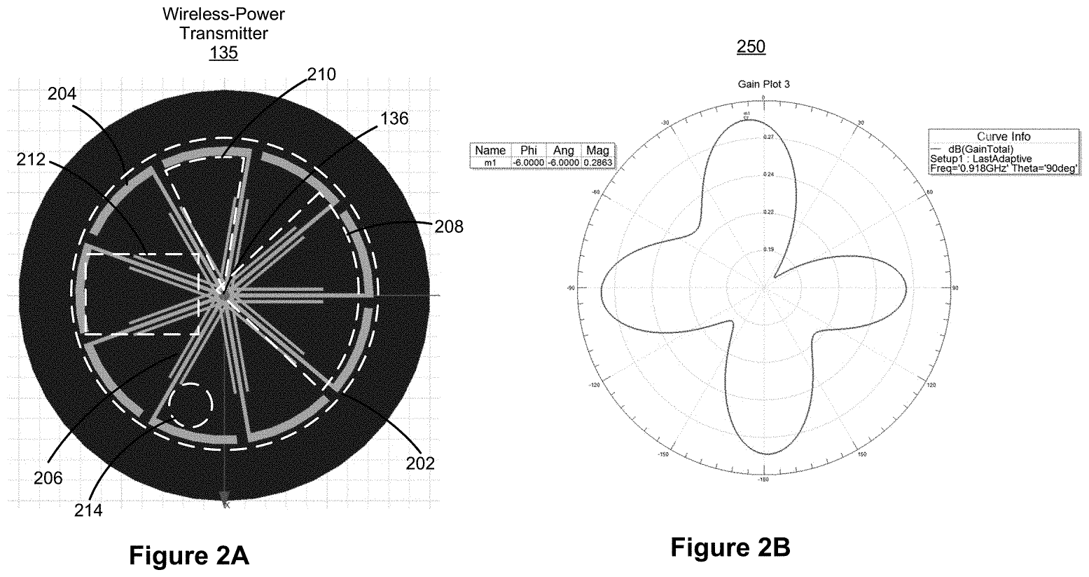

The wireless-power transmitter 135 includes one or more of a transmitter antenna element 136, an E-wall 138 (which includes two E-wall sections positioned and coupled on either side of the transmitter antenna element 136), a power amplifier (not shown), communication components (not shown), and a controller 140. Additional components of the wireless-power transmitter 135 are described in detail below in reference to FIGS. 2, 8A-8D, and 13A-14. In some embodiments, the transmitter antenna element 136 is positioned in a way that is planar with the base of the transmitter device 130 and/or planar with a flat surface on which the transmitter device 130 is placed (e.g. a table, the floor, a counter, a desk, etc.). The transmitter antenna element 136 of the wireless-power transmitter 135 is configured to operate in multiple modes. In some embodiments, the multiple modes include one or more of a standby mode, a single receiver power-transfer mode, and a multi-receiver power-transfer mode.

While the wireless-power transmitter 135 is in standby mode, the wireless-power transmitter 135 does not continuously transmit electromagnetic energy (i.e., generally producing 0 dB or less). In some embodiments, the wireless-power transmitter 135 provides pulse signals to the transmitter antenna element 136 at predetermined time interval (e.g., 20 milliseconds, 50 milliseconds, 100 milliseconds, etc.). The pulse signal is used by the wireless-power transmitter 135 to detect one or more wireless-power receivers 155 at a power-transfer point of the plurality of power-transfer points 202 (FIG. 2). More specifically, the pulse signal causes the transmitter antenna element 136 to transmit electromagnetic energy that is below a threshold amount (e.g., below 0 dB to less than 3 dB) and produce an electric field, which are used to detect one or more wireless-power receivers 155 at a power-transfer point of the plurality of power-transfer points 202 (FIG. 2) (e.g., by detecting reflected power, capacitive coupling, etc.). The electric field of the transmitter antenna element 136 is substantially equally distributed at each of a plurality of power-transfer points 202 (FIG. 2) of the transmitter antenna element 136 (e.g., such that a measurement of the electric field at any particular point along the length of the transmitter antenna element 136 is the same). The standby mode of the wireless-power transmitter 135 and the plurality of power-transfer points 202 are described in more detail below in reference to FIG. 2.

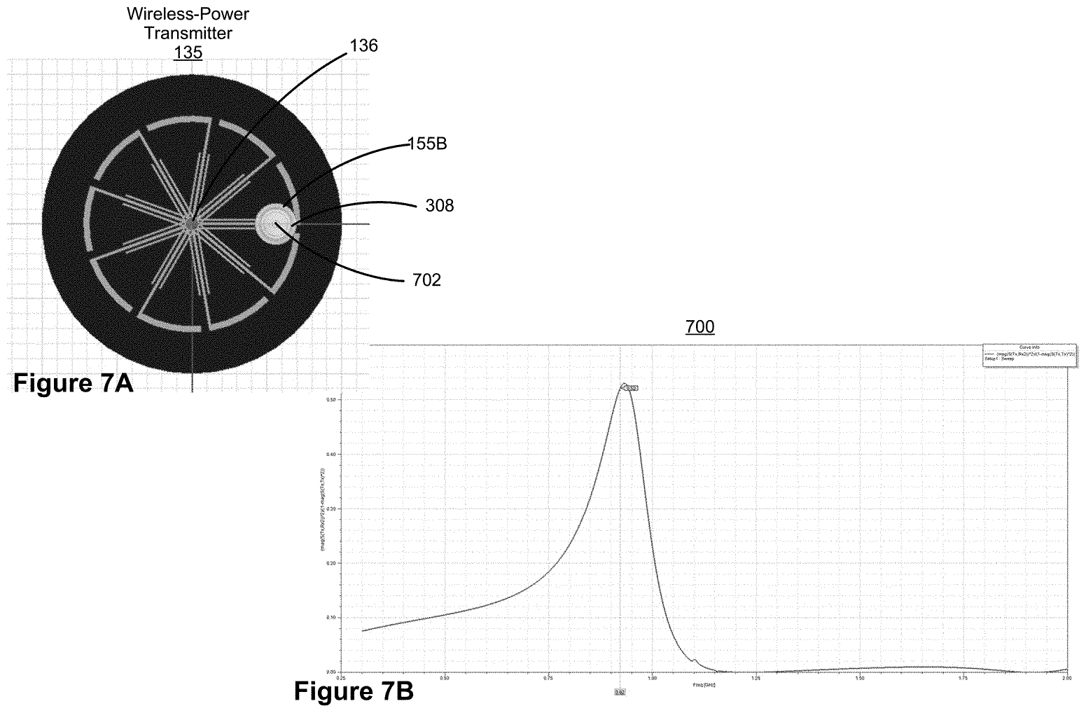

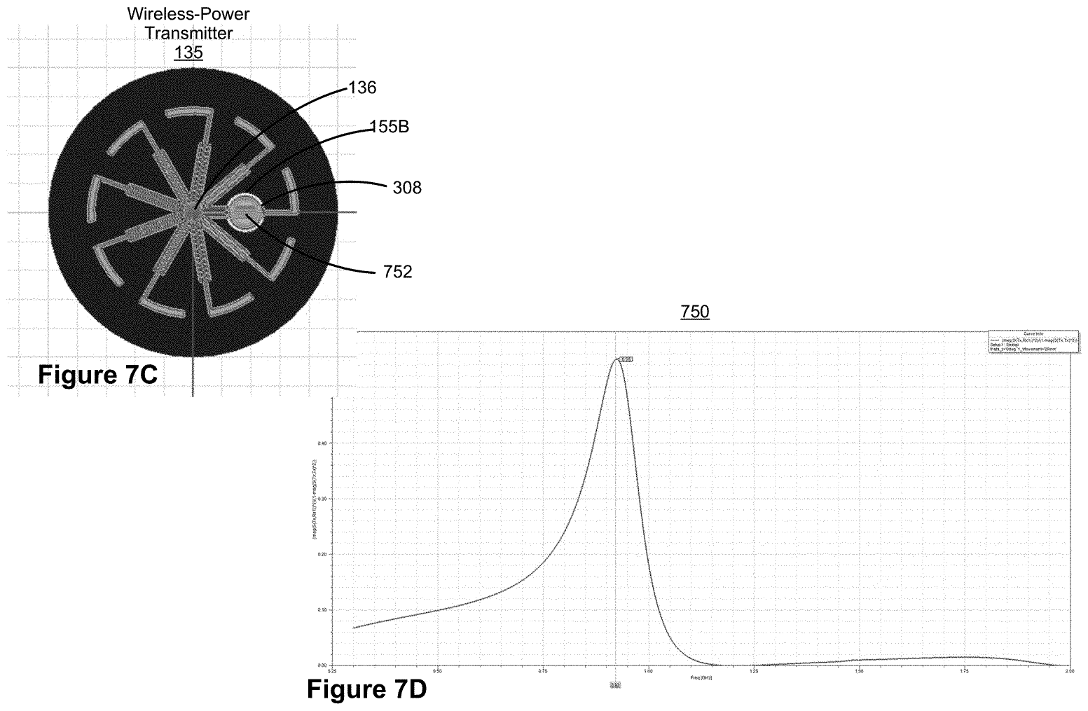

The wireless-power transmitter 135 activates the single receiver power-transfer mode upon a wireless power-receiver 155 coupling (e.g., capacitively coupling) with one of the plurality of power-transfer points 202 of the transmitter antenna element 136. While the wireless-power transmitter 135 is in the single receiver power-transfer mode, a portion of the electric field is greater at the one of the plurality of the power-transfer points 202 than at any other of the plurality power-transfer points 202 of the transmitter antenna element 136, and electromagnetic energy is transferred from the transmitter antenna element 136 to the wireless power-receiver 155 at the one of the plurality of the power-transfer points. The single receiver power-transfer mode of the wireless-power transmitter 135 is described in more detail below in reference to FIGS. 7A-10B.

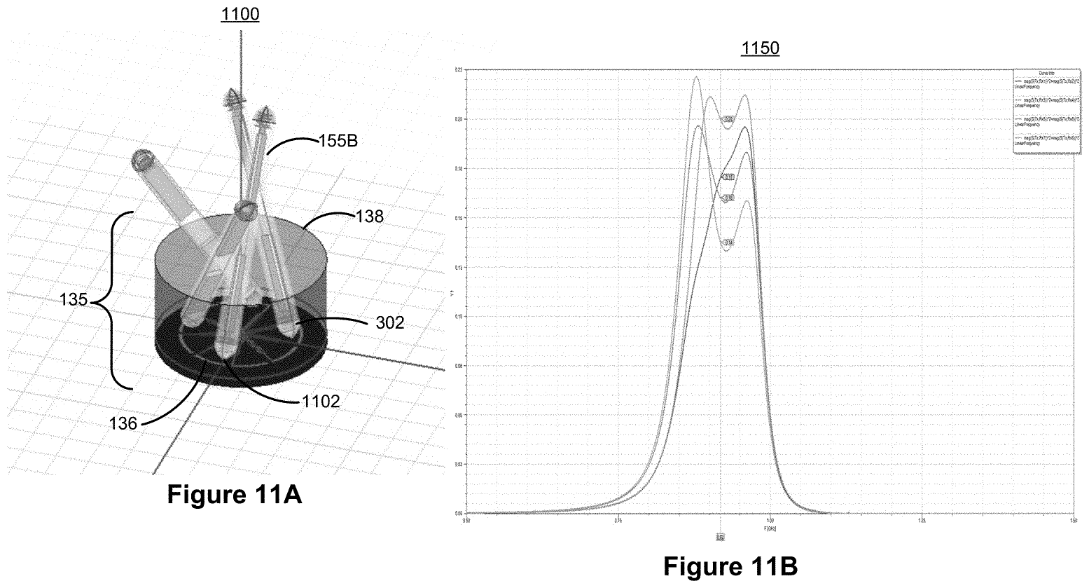

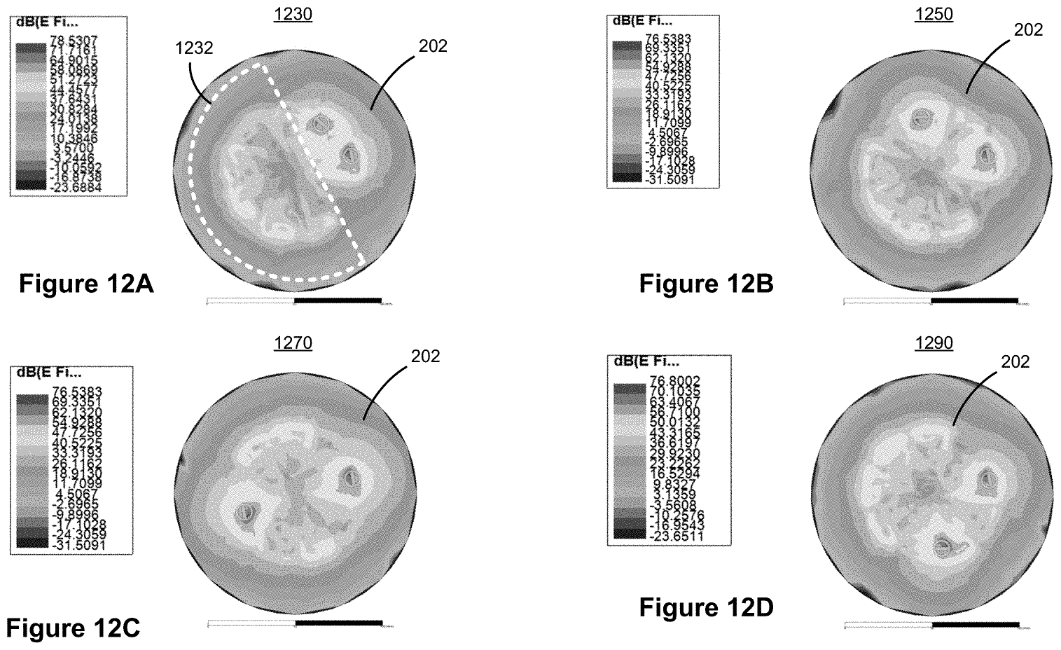

The wireless-power transmitter 135 activates the multi-receiver power-transfer mode upon at least two wireless power-receivers 155 coupling with respective power-transfer points of the plurality of power-transfer points 202. For example, in some embodiments, the multi-receiver power-transfer mode is activated upon at least a first wireless power-receiver 155 coupling with a first power-transfer point of the plurality of power-transfer points 202 of the transmitter antenna element 136, and a second wireless power-receiver 155 coupling with a second power-transfer point of the plurality of power-transfer points 202 of the transmitter antenna element 136 distinct from the first power-transfer point. While the wireless-power transmitter 135 is in the multi-receiver power-transfer mode, respective portions of the electric field are greater at respective power-transfer points of the plurality of power-transfer points 202 (e.g., at the first and second power-transfer points in the example described above) of the transmitter antenna element 136 than at any other vacant power-transfer point (e.g., a power-transfer point to which no wireless-power receiver is coupled) of the plurality power-transfer points 202, and electromagnetic energy is transferred from the transmitter antenna element 136 to the respective wireless power-receivers at the respective power-transfer points of the plurality of power-transfer points 202. In one example, the respective portions of the electric field at both the first power-transfer point and the second power-transfer point are substantially a same value (e.g., within 3 dB of one another). Thus, in this way, the wireless-power transmitter with its antenna element is able to provide a consistent charge at any of its power-transfer points and can provide that same consistent charge to a number of different wireless-power receivers simultaneously. The multi-receiver power-transfer mode of the wireless-power transmitter 135 is described in more detail below in reference to FIGS. 11A-12D.

In some embodiments, the transmitter antenna element 136 of the wireless-power transmitter 135 is coupled with an E-wall 138 that can surround a perimeter of the transmitter antenna element 136 or can surround at least two sides of the transmitter antenna element 136. In some embodiments, the E-wall 138 provides an extension of a ground plane of the transmitter antenna element 136. A non-exhaustive list of the advantages of the E-wall 138 are described below. The E-wall 138 can be configured to modulate a portion of the electric field produced at a power-transfer point of the plurality of the power-transfer points of the transmitter antenna element 136. More specifically, the E-wall 138 helps to modulate the electric field distribution at at least a portion of a top surface of the transmitter antenna element 136 (e.g., a contact point between the wireless-power transmitter 135 and the wireless-power receiver 155 (i.e., at a particular power-transfer point at which the wireless-power transmitter 135 and a wireless-power receiver 155 have capacitively coupled)). In some embodiments, the E-wall 138 can be configured to help maximize the wireless transfer of power (e.g., transfer of electromagnetic energy) from the transmitter antenna element 136 to the wireless-power receiver 155 at a power-transfer point of the plurality of power-transfer points. In particular, the E-wall 138 can be configured to help maximize wireless transfer of power from the transmitter antenna element 136 to the wireless-power receiver 155 at a power-transfer point of the plurality of power-transfer points 202 at which the wireless-power transmitter 135 and the wireless-power receiver 155 have coupled (e.g., capacitively coupled). In some embodiments, the E-wall 138 helps to ensure an advantageous electrical field direction for the power that is wirelessly transmitted from the transmitter antenna element 136 to the wireless-power receiver 155. More specifically, in some embodiments, the E-wall 138 can be configured to direct a portion of the electric field in a substantially vertical direction (e.g., in a direction perpendicular to a top surface of the transmitter antenna element 136) from the transmitter antenna element 136 (e.g., where the portion of the electrical field is transferred at the particular power-transfer point at which the wireless-power transmitter 135 and a wireless-power receiver 155 couple).

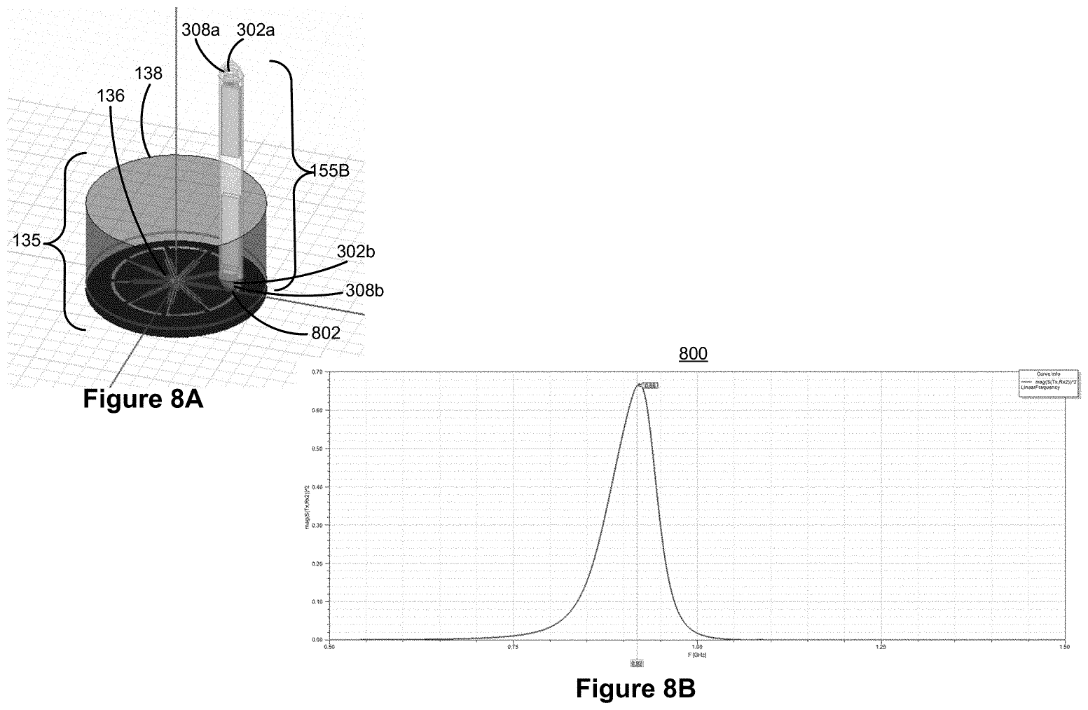

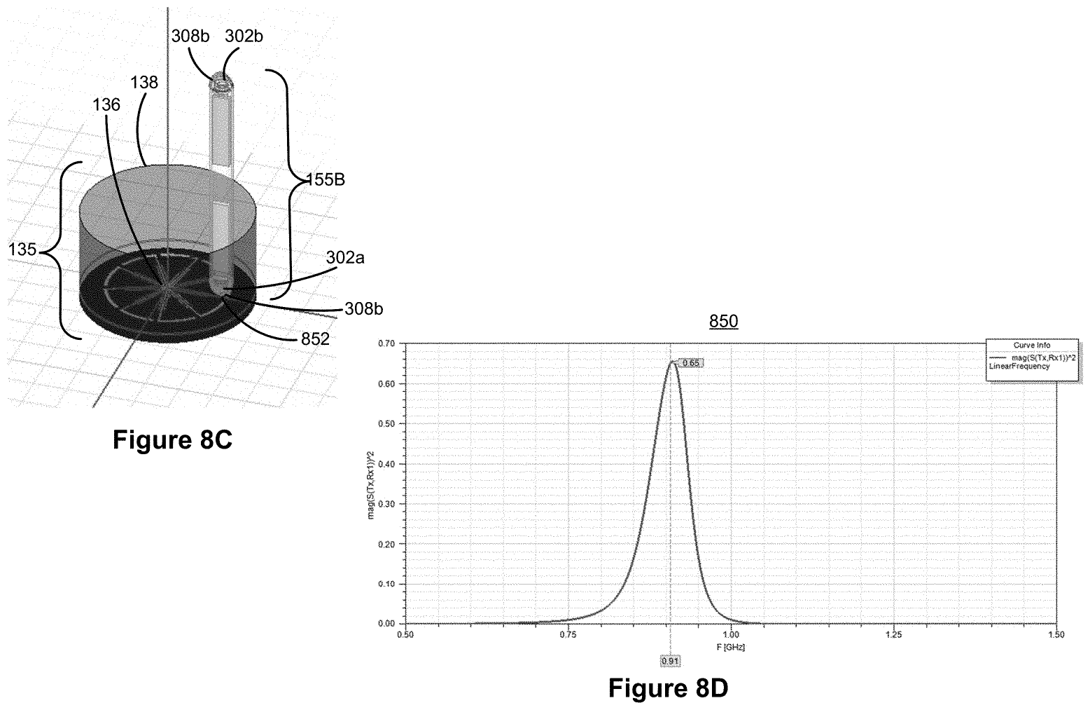

Although the examples provided above are for a single wireless-power receiver 155, the same or similar advantages can be provided to multiple wireless-power receivers 155 at respective power-transfer points of the plurality of the power-transfer points of the transmitter antenna element 136 of a wireless-power transmitter 135. For example, the E-wall 138 helps to modulate the electric field distribution at respective portions of a top surface of the transmitter antenna element 136 at which each wireless-power receiver 155 is located. Performance of the E-wall 138 of the wireless-power transmitter 135 is described in more detail below in reference to FIGS. 8A-10B.

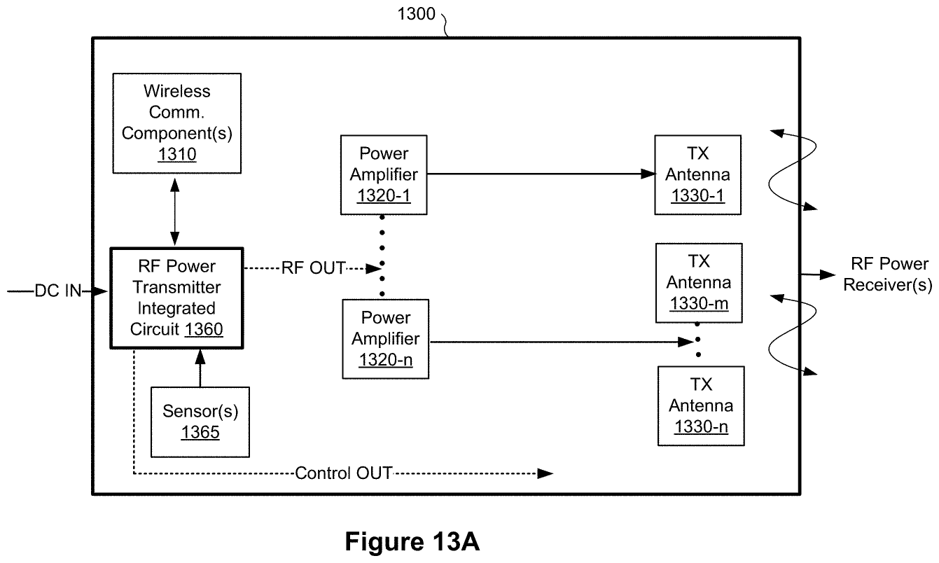

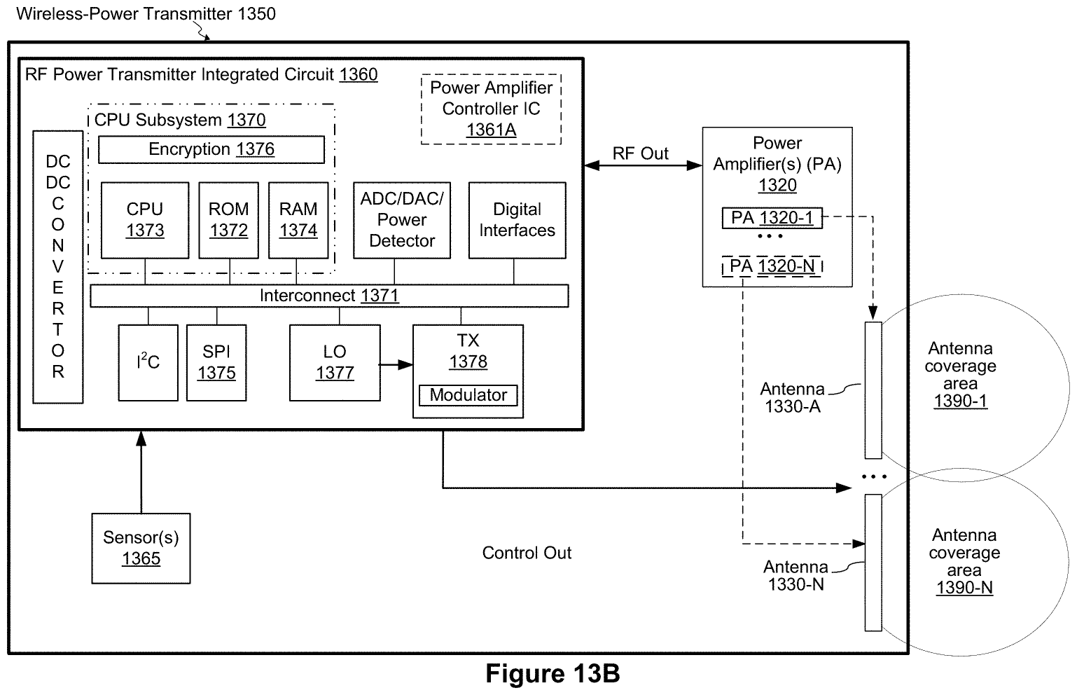

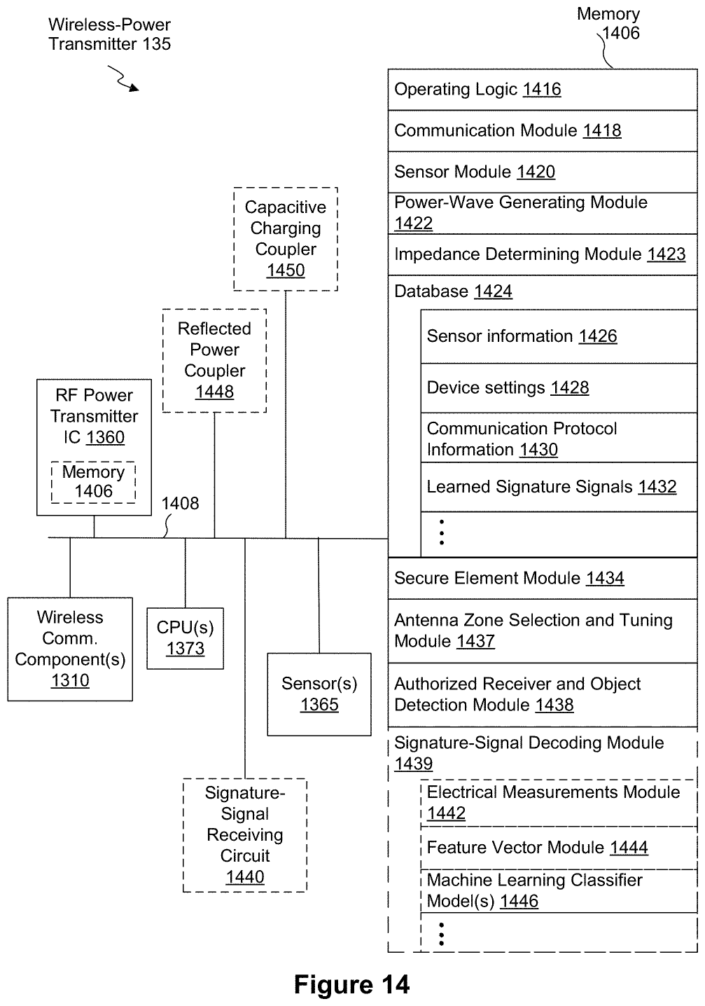

In some embodiments, the wireless-power transmitter 135 includes a controller 140 that can be configured to cause the wireless-power transmitter 135 to switch between the multiple modes. Although the controller 140 can cause the wireless-power transmitter 135 to switch between the multiple modes, the wireless-power transmitter 135 is also able to switch between the multiple modes without the controller 140 (e.g., automatically switching (without a controller 140) between the multiple modes upon detection of one or more wireless-power receivers 155 coupling the respective power-transfer points of the plurality of power-transfer points). In some embodiments, the controller 140 is coupled to a power amplifier (not shown) and configured to cause a power amplifier (not shown) to provide a signal to the transmitter antenna element 136 that is then transmitted as electromagnetic energy (upon coupling occurring with a wireless-power receiver at one of the power-transfer points). In some embodiments, the controller 140 is coupled to a communications component (not shown) and configured to receive from the communications component charging configuration data for a wireless-power receiver 155. The charging configuration data can be used by the controller 140 to determine whether to transfer electromagnetic energy to the wireless power-receiver 155, one or more parameters for ensuring more efficient wireless transfer of electromagnetic energy (e.g., magnitude, duration, power level, etc.), and other charging specific configuration. One or more operations of the controller 140 are described in more detail below in reference to FIGS. 13A-14.

As mentioned above, the transmitter device 130 includes or is coupled with a wireless-power transmitter 135. In some embodiments, the wireless-power transmitter 135 or one or more of its components (e.g., one or more of the transmitter antenna element 136, E-wall 138, the controller 140, and other wireless-power transmitter 135 components), are sized such that they are configured to be placed within a housing of the transmitter device 130. As an illustrative example, a housing of the transmitter device 130 can include a cavity well 134 (or base) and a cavity wall 132, and the transmitter antenna element 136 (and the plurality of power-transfer points) is positioned at the cavity well 134, and the E-wall 138 is positioned at or along the cavity wall 132.

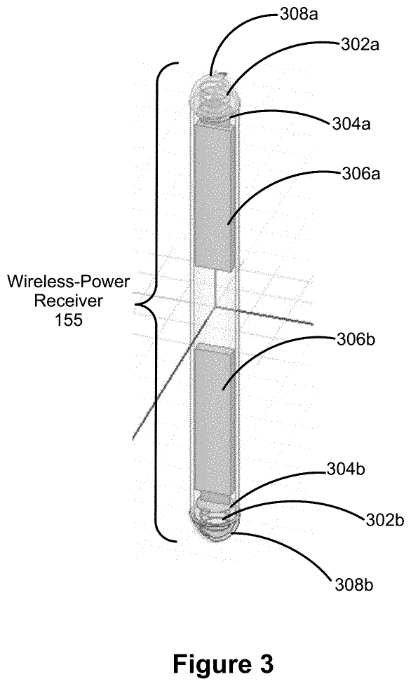

The wireless-power receiver 155 includes one or more antenna elements (shown in at least FIGS. 3-6C) that are configured to capacitively couple with the wireless-power transmitter 135 (and, more specifically, a respective power-transfer point of the transmitter antenna element 136) such that the wireless-power transmitter 135 wirelessly transfers electromagnetic energy to a respective antenna element of the wireless-power receiver 155 at the respective power-transfer point. The wireless-power receiver 155 may also include power conversion circuitry (shown in at least FIGS. 3-6C) coupled to the one or more antenna elements of the wireless-power receiver 155 that is configured to convert the received electromagnetic energy into usable power that can be used to charge a power-storage element, such as a battery. In some embodiments, the battery is part of the electronic device 150. Alternatively, in some embodiments, the battery is part of the wireless-power-receiver 155 and also used to provide power to operate the electronic device 150. Additional components of the wireless-power receiver 155, different configurations, and different functions of the wireless-power receiver 155 are described in more detail below in reference to FIGS. 3-6C and 15.

As mentioned above, the electrical device 150 includes or is coupled to a wireless-power receiver 155. In some embodiments, the wireless-power receiver 155 or one or more of its components (e.g., one or more of the one or more antenna element, power conversion circuitry, and other wireless-power receiver 155 components), are configured to be placed in a housing of the electrical device 150. For example, the electronic device 150 may include a first end 152a (e.g., a top or tip end), which is configured to house a first antenna element of the wireless-power-receiver 155, a second end 152b opposite the first end 152a (e.g., a bottom end), which is configured to house a second antenna element of the wireless-power-receiver 155, and a body section 154 configured to house power conversion circuitry, and other wireless-power receiver 155 components.

FIGS. 2A and 2B illustrate the wireless-power transmitter 135 operating in the standby mode, in accordance with some embodiments. FIG. 2A provides a top view of the wireless-power transmitter 135 and, more specifically, a transmitter antenna element 136 and its plurality of power-transfer points 202. In some embodiments, the transmitter antenna element 136 includes a plurality of sub-antenna elements 204 that extend from a center of the transmitter antenna element 136 to the outer edges of the transmitter antenna element 136 (e.g., extend to the outer dimensions of wireless-power transmitter 135 or the outer dimension of a transmitter device 130 from a center point; FIG. 1), and one or more sleeves 206 (discussed below). In some embodiments, the transmitter antenna element 136 is a low gain antenna element configured to operate at a center frequency of approximately 900 MHz, 920 MHz, 950 MHz (such that the antenna element can still transmit at approximately +/−10 MHz of the center frequency). In some embodiments, the transmitter antenna element 136 is a low gain antenna element configured to operate below 920 MHz (e.g., at 918 MHz).

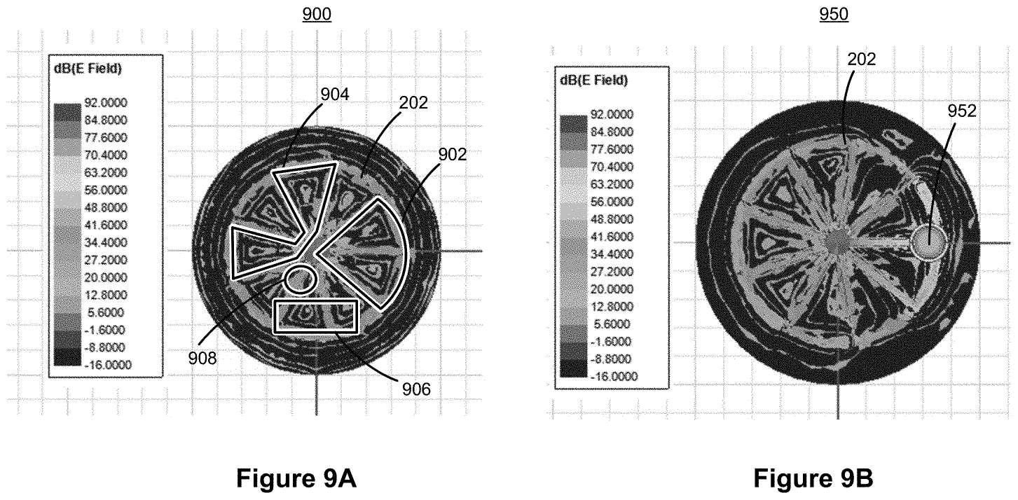

In some embodiments, the plurality of power-transfer points 202 of the transmitter antenna element 136 are on or at any (planar) surface of the transmitter antenna element 136. The plurality of power-transfer points 202 can refer to predetermined sections, regions, or areas of the transmitter antenna element 136 at which electromagnetic energy can be transferred. The predetermined sections, regions, or areas of plurality of power-transfer points 202 can be different sizes, symmetrical, asymmetrical, or combinations thereof. For example, a power-transfer point of the plurality of power-transfer points 202 can include a coverage area between one or more sub-antenna elements of the plurality of sub-antenna elements 204, an area adjacent to the transmitter antenna element 136 or one or more sub-antenna elements of the plurality of sub-antenna elements 204, an location on the transmitter antenna element 136 or one or more sub-antenna elements of the plurality of sub-antenna elements 204, and/or other areas at which electromagnetic energy can be transferred. For example, a first power-transfer point 208 can be a symmetrical region that covers a predetermined portion of the transmitter antenna element 136 (e.g., one fifth of the antenna surface area). In another example, a second power-transfer point 210 can be a trace of one or more sub-antenna elements 204 of the transmitter antenna element 136. In a third example, a third power-transfer point 212 can be any predetermined region or shape covering a surface area of the transmitter antenna element 136 (e.g., square portion covering a sub-antenna element 204). In yet another example, a fourth power-transfer point 214 can be a pinpoint or a localized region of the transmitter antenna element 136. The above-examples are provided for illustrative purposes and are not an exhaustive list of the different plurality of power-transfer points 202 that can be implemented in some embodiments. Additional illustrative examples are provided below in FIG. 9A.

The plurality of power-transfer points 202 are configured to couple with one or more antennas of one or more wireless-power receiver 155 (when placed on a power-transfer point of the plurality of power-transfer points 202). When a wireless-power receiver 155 is placed on a power-transfer point of the plurality of power-transfer points 202, the wireless-power transmitter 135 enters a single receiver power-transfer mode and causes a portion of the electric field at the power-transfer point to be greater than at any other of the plurality power-transfer points (if those other power-transfer points are vacant), and causes electromagnetic energy to transfer from the transmitter antenna element 136 to the wireless-power receiver 155 (i.e., at the power-transfer point). Similarly, when at least two wireless-power receivers 155 couple at respective power-transfer points of the plurality, the wireless-power transmitter 135 enters a multi-receiver power-transfer mode in which the power-transfer points at which the multiple receivers couple each transfer a same amount of power to the receivers, such that the electric field at those power-transfer points at which the multiple receivers couple is greater than at any other of the plurality power-transfer points (if those other power-transfer points are vacant).

In some embodiments, the transmitter antenna element 136 has a substantially symmetric design. Substantially symmetric design means, in some embodiments, that the one or more sub-antenna elements have the same design. In some embodiments, the symmetric pattern design provides low radiation gain on the transmitter antenna element 136. In some embodiments, the transmitter antenna element 136 has a star pattern (with the plurality of sub-antenna elements 204 on the edges of the antenna element). In some embodiments, the low radiation gain on the transmitter antenna element 136 is less than 2 dB to 3 dB when not coupled to a wireless-power receiver 155 (i.e., when a wireless-power receiver 155 is not coupled with a power-transfer point of the plurality power-transfer points 202). In some embodiments, there is no radiation gain on the transmitter antenna element 136 when it is not coupled with a wireless-power receiver 155.

In some embodiments, the plurality of sub-antenna elements 204 include one or more sleeves 206 that are configured to perform impedance matching. In particular, the one or more sleeves 206 can be designed to match the load impedance or reactance of a wireless-power receiver 155 (FIG. 1) for optimal power transfer (when the wireless-power receiver 155 is coupled with a power-transfer point of the plurality of power-transfer points 202 of the transmitter antenna element 136). This impedance matching is affected by many factors, such as matching a wireless-power receiver 155 antenna and the wireless-power transmitter 135 transmitter antenna element 136, output load of the wireless-power receiver 155, antenna angle and position with respect to wireless-power transmitter 135 and wireless-power receiver 155, obstructions between wireless-power transmitter 135 and wireless-power receiver 155 within the plurality of power-transfer points 202, temperature, and system to system variations (sometimes called wireless power hardware variations). These factors are either directly or indirectly observed as measurable electrical changes stimulated by a power beacon (e.g., short low power burst(s) sweeping over different power levels, frequency, position, etc. into a power-transfer point 202 at which a wireless-power receiver 155 is location (or contacting)). In some embodiments, these electrical measurements (e.g., reflective power, forward power, drive current, drive voltage, temperature, etc.) are captured during the beacon and saved as a set of feature values. Additionally or alternatively, in some embodiments, these electrical measurements are provided to the wireless-power transmitter 135 via a communications component of the wireless-power transmitter 135. In some embodiments, the electrical measurements are used by a controller 104 (FIG. 1) the wireless-power transmitter 135 to determine whether to transfer electromagnetic energy to the wireless power-receiver 155, one or more parameters for the electromagnetic energy (e.g., magnitude, duration, etc.), and other charging specific determinations.

Standby mode gain plot 250, illustrates the gain of the wireless-power transmitter 135 when a pulse signal to detect a wireless power-receiver 155 is provided to the transmitter antenna element 136. The pulse signal is provided to the transmitter antenna element 136 at predetermined time intervals (e.g., 20 milliseconds, 50 milliseconds, 100 milliseconds, etc.). In standby mode gain plot 250, no wireless power-receiver 155 is coupled at any of the power-transfer points of the transmitter antenna element 136 of the wireless-power transmitter 135. The standby mode gain plot 250 shows the wireless-power transmitter 135 operating at a center frequency of 918 MHz when the pulse signal is provided. In a standby mode, an electric field of the transmitter antenna element 136 (based on the pulse signal) is substantially equally distributed at each of the plurality of power-transfer points. Additionally, the antenna element radiates (using the pulse signal) less than a threshold amount of electromagnetic energy (e.g., less than 3 dB down to 0 dB) while in the standby mode. In general, while in standby mode, the wireless-power transmitter 135 does not transmit any electromagnetic energy (only transmitting electromagnetic energy when a pulse signal is provided).

FIG. 3 illustrates a wireless-power receiver 155, in accordance with some embodiments. The wireless-power receiver 155 includes one or more of a receiver antenna element 302 coupled to a planar surface of a respective metal feed plate 304, a cap 308, and power conversion circuitry 306. For example, in some embodiments, the wireless-power receiver 155 includes a first receiver antenna element 302a coupled to a first planar surface of a first metal feed plate 304a, and a second receiver antenna element 302b coupled to a first planar surface of a second metal feed plate 304b. FIG. 3 further shows one or more components of the wireless-power receiver 155 within a housing of the electronic device 150 as described above in reference to FIG. 1.

A receiver antenna element 302 of the wireless-power receiver 155 is configured to capacitively couple with a respective power-transfer point of an antenna element of a wireless-power transmitter 135 (e.g., one or the power-transfer points of the transmitter antenna element 136). The wireless-power transmitter 135, upon coupling with a receiver antenna element 302 of the wireless-power receiver 155, transfers electromagnetic energy to the receiver antenna element 302. The metal feed plate 304 coupled to the receiver antenna element 302 causes the electromagnetic energy to be received by the receiver antenna element 302 in a direction perpendicular to its planar surface (i.e., planar surface of the metal feed plate 304 that can be perpendicularly-positioned relative to a length of the wireless-power receiver 155). For example, the first receiver antenna element 302a is configured to capacitively couple with a respective power-transfer point of an antenna element of a wireless-power transmitter 135 such that the wireless-power transmitter 135 (via the respective power-transfer point of the transmitter antenna element 136) wirelessly transfers electromagnetic energy to the first receiver antenna element 302a. The first metal feed plate 304a causes the electromagnetic energy to be received by the first receiver antenna element 302a in a direction perpendicular to its first planar surface (i.e., planar surface of the first metal feed plate 304a). Similarly, the second receiver antenna element 302b is configured to capacitively couple with a respective power-transfer point of an antenna element of the wireless-power transmitter 135 such that the wireless-power transmitter 135 (via the respective power-transfer point of the transmitter antenna element 136) wirelessly transfers electromagnetic energy to the second receiver antenna element 302b. The second metal feed plate 304b causes the electromagnetic energy to be received by the second receiver antenna element 302b in a direction perpendicular to its first planar surface (i.e., planar surface of the second metal feed plate 304b).

In some embodiments, the receiver antenna element 302 is a wire forming a helical pattern. For example, the first receiver antenna element 302a can be shaped into a helical pattern formed from a wire, and the second receiver antenna element 302b can also be shaped into a helical pattern formed from another wire. In some embodiments, the receiver antenna element 302 is positioned perpendicular to the planar surface of the metal feed plate 304. For example, as shown in FIG. 3, the first receiver antenna element 302a is coupled to and positioned perpendicular to the first metal surface 304a, and the second receiver antenna element 302b is coupled to and positioned perpendicular to the second metal surface 304b. In some embodiments, the receiver antenna element 302 has a gain of approximately 2 dBi (+/−10%).

In some embodiments, the power conversion circuitry 306 is coupled to each of the receiver antenna elements 302 (i.e., the one or more receiver antenna elements 302 use the same power conversion circuitry 306, which can be positioned between the first and second receiver antenna elements). For example, in some embodiments, a power conversion circuitry 306 is coupled to a second planar surface (opposite the first planar surface) of the first metal feed plate 304a, and a second planar surface (opposite the first planar surface) of the second metal feed plate 304b; and the power conversion circuitry 306 is configured to receive electromagnetic energy via the first metal feed plate 304a of the first antenna element 302a and via the second metal feed plate 304b of the second antenna element 302b. Alternatively, in some embodiments, a respective (and different) power conversion circuitry 306 is coupled separately to each of the receiver antenna elements 302. For example, in some embodiments, a first power conversion circuitry 306a is coupled to a second planar surface (opposite the first planar surface) of the first metal feed plate 304a, and a second power conversion circuitry 306b is coupled to a second planar surface (opposite the first planar surface) of the second metal feed plate 304b. The first power conversion circuitry 306a being configured to receive electromagnetic energy via the first metal feed plate 304a of the first antenna element 302a, and the second power conversion circuitry 306b being configured to receive electromagnetic energy via the second metal feed plate 304b of the second antenna element 302b. In some embodiments, the power conversion circuitry 306 is configured to convert the electromagnetic energy into usable power for charging a battery that is electrically coupled to the wireless-power receiver 155.

In some embodiments, the cap 308 of the wireless-power receiver 155 is configured to operate as a dielectric. In some embodiments, the cap 308 includes an optional metal interior, but can also have a non-metal interior, such as one made of plastic. In some embodiments, the first receiver antenna element 302a is coupled to a first cap 308a, and the second receiver antenna element 302b is coupled to a second cap 308b. In some embodiments, the cap 308 improves the return loss of the wireless-power receiver 155 such that it has a return loss of approximately 8 dB (+/−1 dB) at a center operating frequency of around 918 MHz.

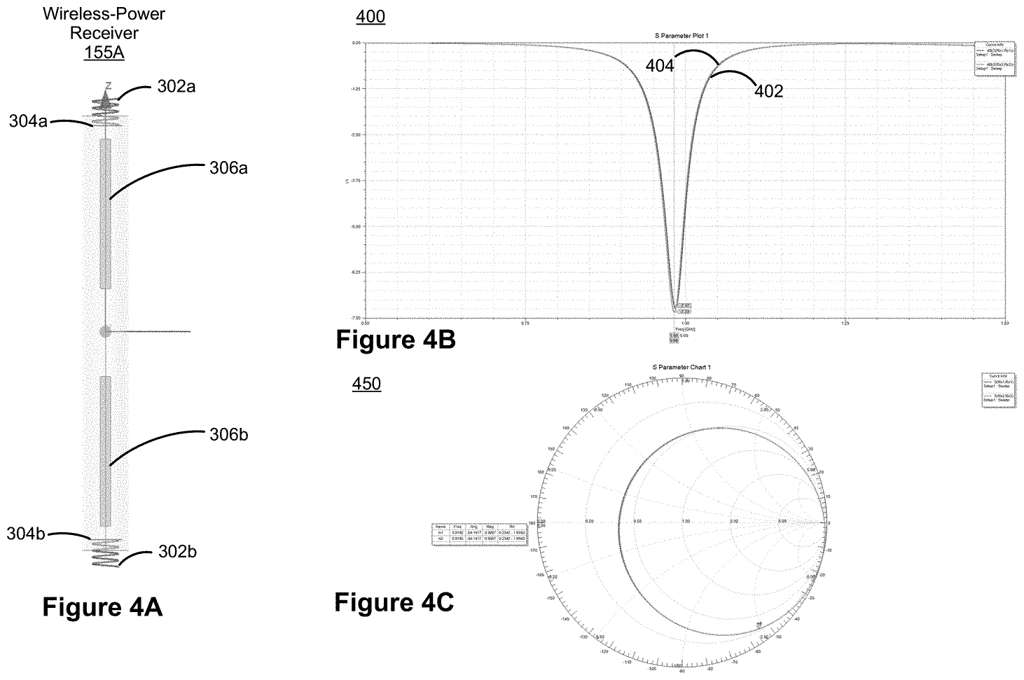

FIGS. 4A-4C illustrate performance of a wireless-power receiver without one or more caps 308, in accordance with some embodiments. FIG. 4A shows a wireless-power receiver 155A that is similar to the wireless-power-receiver 155 described above in reference to FIG. 3, but the wireless-power-receiver 155A depicted in FIG. 4A does not include one or more caps 308. For example, the wireless-power receiver 155A includes a first receiver antenna element 302a coupled to a planar surface of a first metal feed plate 304a, and first power conversion circuitry 306a coupled to the first metal feed plate 304a, as well as a second receiver antenna element 302b coupled to a planar surface of a second metal feed plate 304b, and second power conversion circuitry 306b coupled to the second metal feed plate 304b. In some embodiments, a power-storage element (e.g., a battery) is positioned between and coupled with both the first and second power conversion circuitry, such that usable power produced by these pieces of circuitry can be used to provide power or charge to the power-storage element.

FIG. 4B illustrates the return loss of the wireless-power receiver 155A across a number of different operating frequencies. S parameter plot 400 shows the performance of the first receiver antenna element 302a and the second receiver antenna element 302b. As shown in S parameter plot 400, the receiver antenna elements 302 operating without respective caps 308 have substantially similar return losses at each of the operating frequencies (e.g., a difference of less than 1 dB even at 980 MHz). The return loss for the first receiver antenna element 302a is represented by a first curve line 402 (red), and the return loss for the second receiver antenna element 302b is represented by a second curve line 404 (green).

FIG. 4C illustrates parameters of the antenna elements 302 of the wireless-power receiver 155A plotted on a Smith chart. As is shown in FIG. 4C, at point m1, the receiver antenna elements 302 are operating at a center frequency of 918 MHz with an angle of −54.1417, magnitude of 0.9067, and 0.2342-1.9342i. As is also shown in FIG. 4C, at point m2, the receiver antenna elements 302 are operating at a center frequency of 918 MHz with an angle of −54.1417, magnitude of 0.9067, and 0.2342-1.9342i.

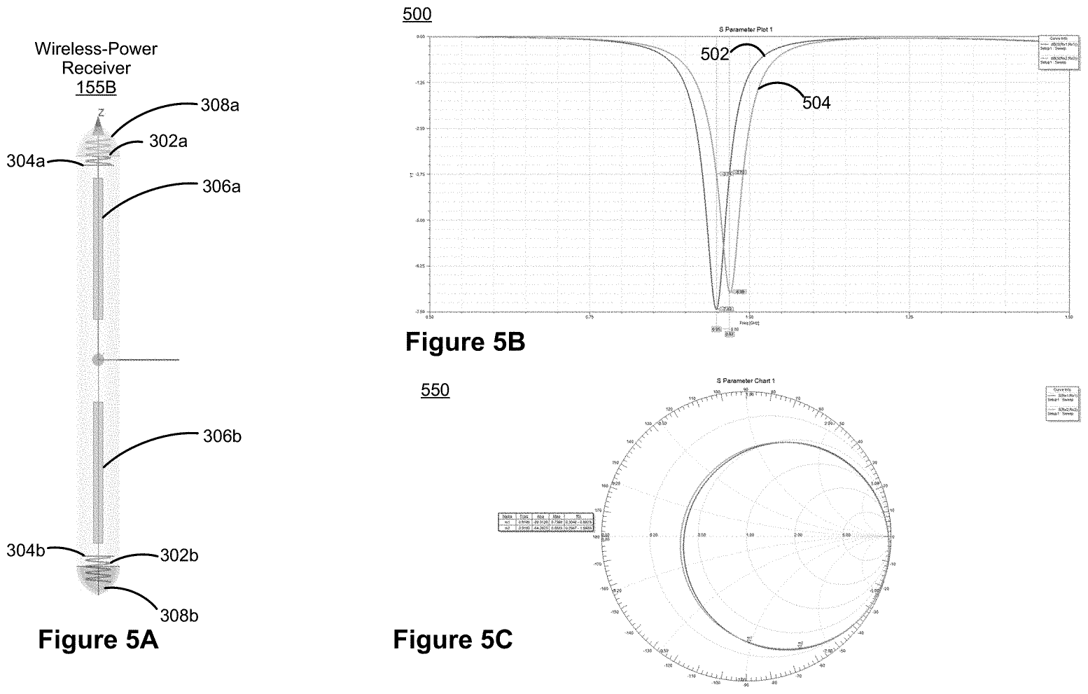

FIGS. 5A-5C illustrate performance of a wireless-power receiver 155B that includes one or more caps 308 having metallic interiors, in accordance with some embodiments. The wireless-power receiver 155B includes a first receiver antenna element 302a coupled to a planar surface of a first metal feed plate 304a, a first cap 308a coupled to the first receiver antenna element 302a, and first power conversion circuitry 306a coupled to the first metal feed plate 304a, as well as a second receiver antenna element 302b coupled to a planar surface of a second metal feed plate 304b, a second cap 308b coupled to the second receiver antenna element 302b and second power conversion circuitry 306b coupled to the second metal feed plate 304b. In this embodiments, the first cap 308a and the second cap 308b include metallic interiors, which be made of a suitable metallic material such as steel, iron, aluminum, copper, etc.

FIG. 5B illustrates the return loss of the wireless-power receiver 155B with the one or more caps 308 having metallic interiors. S parameter plot 500 shows the performance of the first receiver antenna element 302a and the second receiver antenna element 302a. The return loss for the first receiver antenna element 302a is represented by a first curve line 502 (red), and the return loss for the second receiver antenna element 302b is represented by a second curve line 504 (green). In some embodiments, the caps 308 are used to tune the receiver antenna element 302. For example, as shown in FIG. 5B, the first receiver antenna element 302a has a greater return loss at a center frequency of 950 MHz than the second receiver antenna element 302a (which has a higher greater return loss at a center frequency of 970 MHz). In some embodiments, the antenna tuning provided by the caps 308 depends on the type of material (e.g., metallic interior), the thickness of the caps 308, spacing between the receiver antenna element 302 and the caps 308 (e.g., free space between turn in a helical pattern antennas and the caps 308, free space between the top or sides of a receiver antenna element 302 and a cap 308), the size of the caps 308, and other factors. As shown in S parameter plot 500, the receiver antenna elements 302 operating with respective caps 308 (with metallic interiors) have slightly larger variances in return loss and center operating frequencies relative to one another (as compared to the variances in return loss for the antenna elements of the wireless-power receiver 155A) due to the tuning provided by the respective caps 308.

FIG. 5C illustrates parameters of the antenna elements 302 of the wireless-power receiver 155B plotted on a Smith chart. The Smith chart 550 also depicts values of these parameters at two specific measurement points (m1 and m2). As is shown in FIG. 5C, at point m1, the receiver antenna elements 302 are operating at a center frequency of 918 MHz with an angle of −88.3126, a magnitude of 0.7368, and an impedance of 0.3048-0.9823i. As is also shown in FIG. 5C, at point m2, the receiver antenna elements 302 are operating at a center frequency of 918 MHz with an angle of −64.2623, a magnitude of 0.8583, and an impedance of 0.2657-1.5600i.

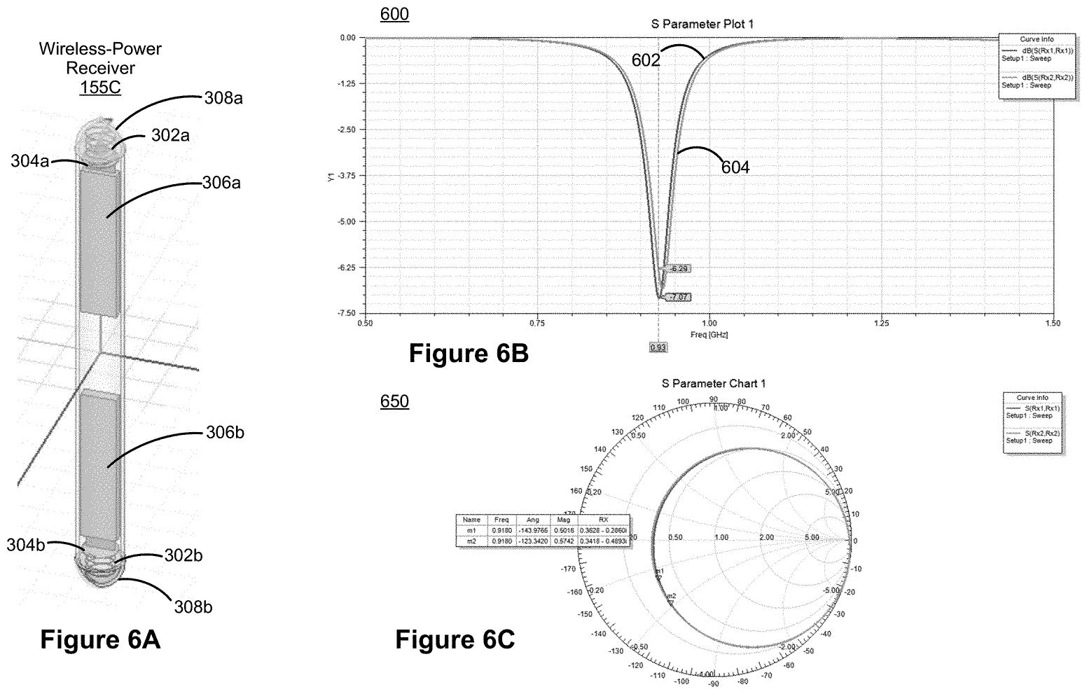

FIGS. 6A-6C illustrates performance of a wireless-power receiver 155C that includes one or more caps 308 having non-metallic interiors, in accordance with some embodiments. The wireless-power receiver 155C includes a first receiver antenna element 302a coupled to a planar surface of a first metal feed plate 304a, a first cap 308a coupled to the first receiver antenna element 302a, and first power conversion circuitry 306a coupled to the first metal feed plate 304a, as well as a second receiver antenna element 302b coupled to a planar surface of a second metal feed plate 304b, a second cap 308b coupled to the second receiver antenna element 302b and second power conversion circuitry 306b coupled to the second metal feed plate 304b. In these embodiments, the first cap 308a and the second cap 308b do not include metallic interiors (e.g., are made of plastic or some other material).

FIG. 6B illustrates the return loss of the wireless-power receiver 155C with the one or more caps 308 (having non-metallic interiors). S parameter plot 600 shows the performance of the first receiver antenna element 302a and the second receiver antenna element 302a. As shown in S parameter plot 600, the receiver antenna elements 302 operating with respective caps 308 (having non-metallic interiors) have substantially similar return loss and center operating frequencies relative to one another. The return loss for the first receiver antenna element 302a is represented by a first curve line 602 (red), and the return loss for the second receiver antenna element 302b is represented by a second curve line 604 (green).

FIG. 6C illustrates parameters of the antenna elements 302 of the wireless-power receiver 155C plotted on a Smith chart. The Smith chart 650 also depicts values of these parameters at two specific measurement points (m1 and m2). As is shown in FIG. 6C, at point m1, the receiver antenna elements 302 are operating at a center frequency of 918 MHz with an angle of −143.97, magnitude of 0.5016, and 0.3628-0.2860i. As is also shown in FIG. 6C, at point m2, the receiver antenna elements 302 is operating at a center frequency of 918 MHz with an angle of −123.34, magnitude of 0.5742, and impedance of 0.3418-0.4893i

FIGS. 7A-7D illustrate the performance of a wireless-power transmitter 135 capacitively coupled with a wireless-power receiver 155B at different operational frequencies, in accordance with some embodiments. In these examples, the wireless-power transmitter 135 is operating in single receiver power-transfer mode.

FIGS. 7A and 7B illustrate a transmitter antenna element of the wireless-power transmitter 135 capacitively coupled with a receiver antenna element 302 of the wireless-power receiver 155B, which capacitive coupling can occur when the wireless-power receiver 155B is within the bottom of the electronic device 150 (FIG. 1). More specifically, FIGS. 7A and 7B show the transmitter antenna element 136 capacitively coupled with a second receiver antenna element 302b of wireless-power receiver 155B (including a respective cap 308) at a power-transfer point 702. Performance plot 700 shows the performance (i.e., coupling efficiency) during the transfer of electromagnetic energy from the transmitter antenna element 136 of the wireless-power transmitter 135 to the second receiver antenna element 302b of the wireless-power receiver 155B, based on measurements of coupling efficiency at different operational frequencies. In some embodiments, while the wireless-power transmitter 135 is in the single receiver power-transfer mode, the transmitter antenna element 136 has a gain of approximately 2 dBi (+/−10%). In some embodiments, while the wireless-power transmitter 135 is in the single receiver power-transfer mode, the transmitter antenna element 136 couples with the second receiver antenna element 302b of the wireless-power receiver 155B at a coupling efficiency of at least 50% or higher (e.g., 60%, 65%, 70%, or 75%). In some embodiments, the second receiver antenna element 302b has a gain of at least 2 dBi. In the example of FIG. 7B, as shown in performance plot 700, the coupling efficiency is approximately 52% at a center operating frequency of 920 MHz.

FIGS. 7C and 7D illustrate the transmitter antenna element of the wireless-power transmitter 135 capacitively coupled with a receiver antenna element 302 of the wireless-power receiver 155B, which capacitive coupling can occur when the wireless-power receiver 155B is within the tip (or top) of the electronic device 150 (FIG. 1). More specifically, FIGS. 7C and 7D show the transmitter antenna element 136 capacitively coupled with a first receiver antenna element 302a of wireless-power receiver 155B (including a respective cap 308) at a power transfer point 752. Performance plot 750 shows the performance (i.e., coupling efficiency) during the transfer of electromagnetic energy from the transmitter antenna element 136 of the wireless-power transmitter 135 to the first receiver antenna element 302a of the wireless-power receiver 155B, based on measurements of coupling efficiency at different operational frequencies. In some embodiments, while the wireless-power transmitter 135 is in the single receiver power-transfer mode, the transmitter antenna element 136 couples with the first receiver antenna element 302a of the wireless-power receiver 155B at a coupling efficiency of at least 50% or higher (e.g., 60%, 65%, 70%, or 75%). In some embodiments, the first receiver antenna element 302a has a gain of approximately 2 dBi (+/−10%). In the example of FIG. 7D, as shown in performance plot 750, the coupling efficiency is approximately 55% at a center operating frequency of 920 Mhz.

FIGS. 8A-8D illustrate the performance of a wireless-power transmitter 135 with an E-wall 138 capacitively coupled with a wireless-power receiver 155B at different operational frequencies, in accordance with some embodiments. In these examples, the wireless-power transmitter 135 is operating in single receiver power-transfer mode. FIGS. 8A-8D, when compared to FIGS. 7A-7D, illustrate the improved performance of a wireless-power transmitter 135 with an E-wall 138 over a wireless-power transmitter 135 without an E-wall 138. While the E-wall 138 does help to improve performance, it is still an optional component that is not a part of all embodiments within the scope of this disclosure.

FIGS. 8A and 8B illustrate a transmitter antenna element of the wireless-power transmitter 135 capacitive coupled with a receiver antenna element 302 of the wireless-power receiver 155B, which capacitive coupling can occur when the wireless-power receiver 155B is placed within the electronic device 150 (FIG. 1), such that the wireless-power receiver 155B contacts a bottom surface of the electronic device 150, the transmit antenna element 136 of the wireless-power transmitter 135 being positioned underneath that bottom surface. More specifically, FIGS. 8A and 8B show the transmitter antenna element 136 capacitively coupled with a second receiver antenna element 302b of wireless-power receiver 155B (including a respective cap 308) at a power-transfer point 802. In some embodiments, the wireless-power transmitter 135 uses the E-wall 138 to extend the ground plane, help to modulate electric field distribution across the plurality of power-transfer points 202 (FIG. 2) at a top surface (e.g., a surface that is directly below the bottom surface of the electronic device 150 that was discussed above) of the wireless-power transmitter 135 surface, maximize the power transferred at a desired location (i.e., power-transfer point at which the wireless-power receiver 155B is coupled to the transmitter antenna element), and/or ensure that the electric field produced by the wireless-power transmitter 155B propagates in a vertical direction (i.e., a direction perpendicular to the bottom surface of the electronic device 150). In some embodiments, the E-wall 138 maximizes the power transferred at a desired location by maximizing the electromagnetic field strength on top of the wireless-power transmitter 135 charging surface (e.g., the plurality of power-transfer points 202 of an antenna element 136).

In some embodiments, the size and/or configurations of the E-wall 138 is based on the size of the wireless-power transmitter 135 charging surface such that the electromagnetic field strength is maximized at the top of the wireless-power transmitter 135 charging surface. In some embodiments, the large the wireless-power transmitter 135 charging surface, the shorter (i.e. less) the height of the E-wall 138 is. Alternatively, in some embodiments, the smaller the wireless-power transmitter 135 charging surface, the greater the height of the E-wall 138 is. More specifically, the size (e.g. height) and configurations of the E-wall 138 are frequency dependent. The size (e.g. height) and configurations of the E-wall 138 (operating as an extended ground plane) are used to achieve a target wavelength. Different configurations and sizes of the E-wall 138 can be used to optimize the wireless-power transmitter 135's wireless-power transfer.

Performance plot 800 shows the performance (i.e., coupling efficiency) during the transfer of electromagnetic energy from the transmitter antenna element 136 of the wireless-power transmitter 135 to the second receiver antenna element 302b of the wireless-power receiver 155B, based on measurements of coupling efficiency at different operational frequencies. In some embodiments, while the wireless-power transmitter 135 is in the single receiver power-transfer mode, the transmitter antenna element 136 has a gain of approximately 2 dBi (+/−10%). In some embodiments, while the wireless-power transmitter 135 is in the single receiver power-transfer mode, the transmitter antenna element 136 couples with the second receiver antenna element 302b of the wireless-power receiver 155B at a coupling efficiency of at least 50% or higher (e.g., 60%, 65%, 70%, or 75%). In some embodiments, the second receiver antenna element 302b has a gain of approximately 2 dBi (+/−10%). In the example of FIG. 8B, as shown in performance plot 800, the coupling efficiency is approximately 66% at a center operating frequency of 920 MHz.

FIGS. 8C and 8D illustrate a transmitter antenna element of the wireless-power transmitter 135 capacitively coupled with a receiver antenna element 302 of the wireless-power receiver 155B, which capacitive coupling can occur when the wireless-power receiver 155B is placed within the electronic device 150 (FIG. 1), such that the wireless-power receiver 155B contacts a top (or tip) surface of the electronic device 150, the transmit antenna element 136 of the wireless-power transmitter 135 being positioned underneath that bottom surface. More specifically, FIGS. 8C and 8D show the transmitter antenna element 136 capacitively coupled with a first receiver antenna element 302a of wireless-power receiver 155B at a power-transfer point 852. Performance plot 850 shows the performance (i.e., coupling efficiency) during the transfer of electromagnetic energy from the transmitter antenna element 136 of the wireless-power transmitter 135 to the first receiver antenna element 302a of the wireless-power receiver 155B, based on measurements of coupling efficiency at different operational frequencies. In some embodiments, while the wireless-power transmitter 135 is in the single receiver power-transfer mode, the transmitter antenna element 136 couples with the first receiver antenna element 302a of the wireless-power receiver 155B at a coupling efficiency of at least 50% or higher (e.g., 60%, 65%, 70%, or 75%). In some embodiments, the first receiver antenna element 302a has a gain of approximately 2 dBi (+/−10%). In the example of FIG. 8D, as shown in performance plot 850, the coupling efficiency is approximately 65% at a center operating frequency of 910 Mhz.

FIGS. 9A and 9B illustrate the electric field produced at the transmitter antenna element 136 (and the plurality of power-transfer points 202; FIG. 2), in accordance with some embodiments. FIGS. 9A and 9B illustrate the electric field for a wireless-power transmitter 135 (that includes the transmitter antenna element 136) without an E-wall. Electric field radiation plot 900 shows the different measured dB values at each of plurality of power-transfer points 202 of the antenna element 136 while the wireless-power transmitter 135 is in standby mode and providing a pulse signal. As described above, a pulse signal is provided (at predetermined time intervals, such as 20 milliseconds, 50 milliseconds, 100 milliseconds, etc.) to the transmitter antenna element 136 to detect one or more wireless power-receivers 155B at a power-transfer point of the plurality of power-transfer points 202. While in standby mode and a pulse signal is provided, the plurality of power-transfer points 202 of the antenna element 136 have a substantially uniform electric field (e.g., less than 10 dB difference in the electric field between a respective power-transfer point with a lowest electric field as compared to a different power-transfer point with a highest electric field). In the embodiments in which such pulse signaling is used to detect receivers (in other embodiments, the system can remain on at all times and no pulse signaling is used); however, when no pulse signal is provided to the transmitter antenna element 136, the wireless-power transmitter 135 does not transmit any electromagnetic energy therefore improving user safety by minimizing the SAR values at the wireless-power transmitter 135.

Electric field radiation plot 900 also illustrates examples of the power-transfer points with different shapes and sizes. As described above in reference in FIG. 2, the plurality of power-transfer points 202 can refer to predetermined sections, regions, or areas of the transmitter antenna element 136 at which electromagnetic energy can be transferred. The predetermined sections, regions, or areas of plurality of power-transfer points 202 can be different sizes, symmetrical, asymmetrical, or combinations thereof. For example, a first power-transfer point 902 can be a symmetrical region that covers a predetermined portions of the transmitter antenna element 136 (e.g., one fifth of the antenna surface area). In another example, a second power-transfer point 904 can be a trace of a surface area of every other sub-antenna element (e.g., sub-antenna elements 204; FIG. 2) of the transmitter antenna element 136. In a third example, a third power-transfer point 906 can be any predetermined region or shape covering a surface area of the transmitter antenna element 136 (e.g., square portion covering an outer diameter of the antenna surface area). In yet another example, a fourth power-transfer point 908 can be a pinpoint or a localized region of the transmitter antenna element 136. The above-examples are provided for illustrative purposes and are not an exhaustive list of the different plurality of power-transfer points 202 that can be implemented in some embodiments.

Electric field radiation plot 950 shows the different measured dB values along different plurality of power-transfer points 202 of the transmitter antenna element 136 while the wireless-power transmitter 135 is in single receiver power-transfer mode (i.e., a wireless-power receiver 155B is coupled to the wireless-power transmitter 135 at a particular power-transfer point (e.g., target transfer point 952)). While in single receiver power-transfer mode, the wireless-power transmitter 135 causes a portion of the electric field at the power-transfer point to be greater than at any other of the plurality power-transfer points (if vacant). For example, the electric filed is substantially greater at the target power-transfer point 952 (or the receiver antenna element 302) than at any other plurality power-transfer point (e.g., approximately 40-50 dB difference in electric field). The target power-transfer point 952 is the location at which the wireless-power transmitter 135 and the wireless-power receiver 155B are capacitively coupled. As was discussed above, the power-transfer point 952 is depicted in this example as having a circular shape, but various different shapes and sizes for the power-transfer points are within the scope of this disclosure (additional examples of the power-transfer points with different shapes and sizes are provided above in reference to FIG. 9A).

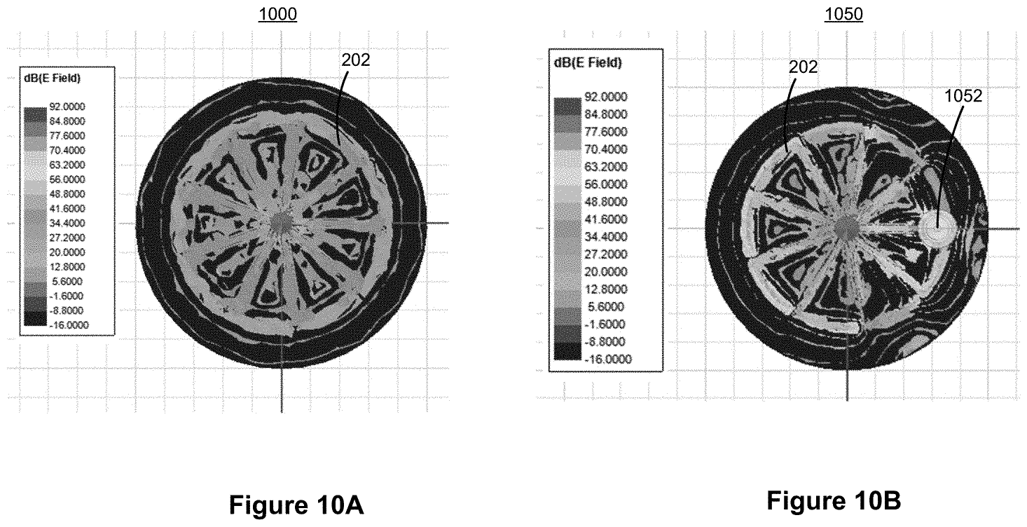

FIGS. 10A and 10B illustrate the electric field of a wireless-power transmitter 135 with an E-wall 138 (FIG. 1) at the transmitter antenna element 136 (and the plurality of power-transfer points 202; FIG. 2), in accordance with some embodiments. Electric field radiation 1000 shows the different measured dB values along different plurality of power-transfer points of the antenna element 136 while the wireless-power transmitter 135 is in standby mode and providing a pulse signal. As described above, a pulse signal is provided (at predetermined time intervals) to the transmitter antenna element 136 to detect a wireless power-receiver 155B at a power-transfer point of the plurality of power-transfer points 202. While in standby mode and a pulse signal is provided, the plurality of power-transfer points 202 of the transmitter antenna element 136 have a substantially uniform electric filed (e.g., less than 10 dB difference in the electric field). However, when no pulse signal is provided to the transmitter antenna element 136, the wireless-power transmitter 135 does not transmit any electromagnetic energy therefore improving user safety by minimizing the SAR values at the wireless-power transmitter 135.

Electric field radiation 1050 shows the different measured dB values along different plurality of power-transfer points 202 of the antenna element 136 while the wireless-power transmitter 135 is in single receiver power-transfer mode (i.e., a wireless-power receiver 155B is coupled to the wireless-power transmitter 135 at a particular power-transfer point (e.g., target power-transfer point 1052)). While in single receiver power-transfer mode, the wireless-power transmitter 135 causes a portion of the electric field at the power-transfer point (which is coupled to a wireless-power receiver 155B) to be greater than at any other of the plurality power-transfer points (if vacant). For example, the electric filed is substantially greater at the target power-transfer point 1052 than at any other plurality power-transfer point (e.g., approximately 40-50 dB difference in electric field). As further shown in electric field radiation 1050, the electric field is focused on the target power-transfer point 1052 itself (i.e., on the surface of the wireless-power transmitter 135 instead of the receiver antenna element 302 as shown in FIG. 9B).

FIGS. 11A and 11B illustrate the performance of a wireless-power transmitter 135 with an E-wall 138 capacitively coupled with multiple wireless-power receivers 155B at different operational frequency, in accordance with some embodiments. In these examples, the wireless-power transmitter 135 is operating in multi-receiver power-transfer mode.

FIGS. 11A and 11B illustrate the wireless-power transmitter 135 capacitive coupled with receiver antenna elements 302 of multiple wireless-power receivers 155B, which capacitively coupling can occur when the wireless-power receivers 155B are within respective electronic devices 150 (FIG. 1). More specifically, as shown in overview 1100 the transmitter antenna element 136 is capacitively coupled with respective receiver antenna elements 302 of each wireless-power receiver 155B at respective power-transfer points (e.g., first power-transfer point 1102). As described above in reference to FIGS. 1 and 8A-8D, the wireless-power transmitter 135 uses the E-wall 138 improve the transfer of electromagnetic energy. For example, the E-wall 138 can be used to modulate the electric field distribution on the top of the wireless-power transmitter 135 surface (i.e., the plurality power-transfer points 202; FIG. 2) for each capacitively coupled wireless-power receiver 155B (e.g., at the first power-transfer point 1102), and/or maximize the power transfer to the desired location (i.e., power-transfer point at which the wireless-power receivers 155B are coupled). The E-wall 138 also provides other advantages described above in reference to FIG. 1.

Performance plot 1150 shows the performance (i.e., coupling efficiency) during the transfer of electromagnetic energy from the transmitter antenna element 136 of the wireless-power transmitter 135 to each of the receiver antenna elements 302 of the wireless-power receivers 155B, based on measurements of coupling efficiency at different operational frequencies. In some embodiments, while the wireless-power transmitter 135 is in the multi-receiver power-transfer mode, the transmitter antenna element 136 has a gain of approximately 2 dBi (+/−10%). In some embodiments, while the wireless-power transmitter 135 is in the multi-receiver power-transfer mode, the transmitter antenna element 136 couples with the receiver antenna elements 302 of the wireless-power receivers 155B at a combined coupling efficiency of at least 50% or higher (e.g., 60%, 65%, 70%, or 75%). In other words, the combined sum of each (capacitively coupled) wireless-power receiver 155B's coupling efficiency (e.g., a coupling efficiency for each wireless-power receiver 155B is added together) is at least 50% and higher. Each wireless-power receiver 155B can have the same or distinct coupling efficiencies. In the example of FIG. 11B, as shown in performance plot 1150, the coupling efficiency for a first wireless-power receivers 155B is approximately 20%, the coupling efficiency for a second wireless-power receivers 155B is approximately 17%, the coupling efficiency for a third wireless-power receivers 155B is approximately 16%, the coupling efficiency for a fourth wireless-power receivers 155B is approximately 14% at a center operating frequency of 920 MHz (for a combined coupling efficiency of 67%). In some embodiments, each receiver antenna element 302 has a gain of approximately 2 dBi (+/−10%).

FIGS. 12A-12D illustrate the electric field of a wireless-power transmitter 135 with an E-wall 138 (FIG. 1) at the transmitter antenna element 136 (and the plurality of power-transfer points 202; FIG. 2), in accordance with some embodiments. More specifically, FIGS. 12A-12D show the wireless-power transmitter 135 in multi-receiver power-transfer mode and the electric field at the plurality of power-transfer points.

A first electric field radiation plot 1230, second electric field radiation plot 1250, third electric field radiation plot 1270, and fourth electric field radiation plot 1290 show that wireless-power receivers 155B have been capacitively coupled with the transmitter antenna element 136 at different power-transfer points of the plurality of power-transfer points. Each of these electric field radiation plots shows that the electric field is uniform at each vacant power-transfer point of the plurality of power-transfer points (e.g., vacant region 1232). Alternatively, the wireless-power transmitter 135 causes respective portions of the electric field at each power-transfer point (coupled to a wireless-power receiver 155B) to be greater than any other of the plurality power-transfer points (if vacant). For example, in each electric field radiation, the electric filed is substantially greater at the power-transfer point that includes a wireless-power receiver 155B (e.g., approximately 40-50 dB difference in electric field).

FIG. 13A is a block diagram of a wireless-power transmitter, in accordance with some embodiments. The block diagram of a wireless-power transmitter 1300 corresponds to an example of the components that can be included within the wireless-power transmitter 135 described above in reference to FIGS. 1-12D. The wireless-power transmitter 135 can be referred to herein as a near-field (NF) power transmitter device, transmitter, power transmitter, or wireless-power transmitter device. The wireless-power transmitter 135 includes one or more of one or more communications components 1310, one or more power amplifier units 1320-1, . . . 1320-n, one or more power-transfer elements (e.g., such as antennas 1330-1 to 1330-n (which can be instances of the transmitter antenna elements 136; FIGS. 1-12D)), an RF Power Transmitter Integrated Circuit (RFIC) 1360 (e.g., analogous to controller 140 FIGS. 1-2B), and one or more sensors 1365.

In some embodiments, the communication component(s) 1310 (e.g., wireless communication components, such as WI-FI or BLUETOOTH radios) enable communication between the wireless-power transmitter 135 and one or more communication networks. In some embodiments, the communication component(s) 1310 are capable of data communications using any of a variety of custom or standard wireless protocols (e.g., IEEE 802.15.4, Wi-Fi, ZigBee, 6LoWPAN, Thread, Z-Wave, Bluetooth Smart, ISA100.11a, WirelessHART, MiWi, etc.) custom or standard wired protocols (e.g., Ethernet, HomePlug, etc.), and/or any other suitable communication protocol, including communication protocols not yet developed as of the filing date of this document.

In some embodiments, the communication component(s) 1310 receives charging information from a wireless-power receiver (or from an electronic device configured to be charged by the wireless-power receiver; e.g., a wireless-power receiver 155 described above in reference to FIGS. 1-12D). In some embodiments, the charging information is received in a packet of information that is received in conjunction with an indication that the wireless-power receiver is located within one meter of the wireless-power transmitter 135. In some embodiments, the charging information includes the location of the wireless-power receiver 155 within the transmission field of the wireless-power transmitter 135 (or the surrounding area within the communications component(s) range). For example, communication components 1310, such as BLE communications paths operating at 2.4 GHz, to enable the wireless-power transmitter 135 to monitor and track the location of the wireless-power receiver 155. The location of the wireless-power receiver 155 can be monitored and tracked based on the charging information received from the wireless-power receiver 155 via the communications components 1310.

In some embodiments, the charging information indicates that a wireless-power receiver 155 is authorized to receive wirelessly-delivered power from the wireless-power transmitter 135. More specifically, the wireless-power receiver can use a wireless communication protocol (such as BLE) to transmit the charging information as well as authentication information to the one or more integrated circuits (e.g., RFIC 1360) of the wireless-power transmitter 135. In some embodiments, the charging information also includes general information such as charge requests from the receiver, the current battery level, charging rate (e.g., effectively transmitted power or electromagnetic energy successfully converted to usable energy), device specific information (e.g., temperature, sensor data, receiver requirements or specifications, and/or other receiver specific information), etc.

In some instances, the communication component(s) 1310 are not able to communicate with wireless-power receivers for various reasons, e.g., because there is no power available for the communication component(s) 1310 to use for the transmission of data signals or because the wireless-power receiver itself does not actually include any communication component of its own. As such, in some embodiments, the wireless-power transmitters 135 described herein are still able to uniquely identify different types of devices and, when a wireless-power receiver 155 is detected, figure out if that the wireless-power receiver 155 is authorized to receive wireless-power (e.g., by measuring impedances, reflected power, and/or other techniques).

The one or more power amplifiers 1320 are configured to amplify an electromagnetic signal that is provided to the one or more antennas 1330. In some embodiments, the power amplifier 1320 used in the power transmission system controls both the efficiency and gains of the output of the power amplifier. In some embodiments, the power amplifier used in the power transmission system is a class E power amplifier 1320. In some embodiments, the power amplifier 1320 used in the power transmission system is a Gallium Nitride (GaN) power amplifier. In some embodiments, the wireless-power transmitters 135 is configured to control operation of the one or more power amplifiers 1320 when they drive one or more antennas 1330. In some embodiments, one or more of the power amplifiers 1320 are a variable power amplifier including at least two power levels. In some embodiments, a variable power amplifier includes one or more of a low power level, median power level, and high power level. As discussed below in further detail, in some embodiments, the wireless-power transmitters 135 is configured to select power levels of the one or more power amplifiers. In some embodiments, the power (e.g., electromagnetic power) is controlled and modulated at the wireless-power transmitters 135 via switch circuitry as to enable the wireless-power transmitters 135 to send electromagnetic energy to one or more wireless receiving devices (e.g., wireless-power receivers 155) via the one or more antennas 1330.

In some embodiments, the output power of the single power amplifier 1320 is equal or greater than 2 W. In some embodiments, the output power of the single power amplifier 1320 is equal or less than 15 W. In some embodiments, the output power of the single power amplifier 1320 is greater than 2 W and less than 15 W. In some embodiments, the output power of the single power amplifier 1320 is equal or greater than 4 W. In some embodiments, the output power of the single power amplifier 1320 is equal or less than 8 W. In some embodiments, the output power of the single power amplifier 1320 is greater than 4 W and less than 8 W. In some embodiments, the output power of the single power amplifier 1320 is greater than 8 W and up to 50 W.

In some embodiments, by using the single power amplifier 1320 with an output power range from 2 W to 15 W, the electric field within the power transmission range of the antenna 1330 controlled by the single power amplifier 1320 is at or below a SAR value of 1.6 W/kg, which is in compliance with the FCC (Federal Communications Commission) SAR requirement in the United States. In some embodiments, by using a single power amplifier 1320 with a power range from 2 W to 15 W, the electric field within the power transmission range of the antenna 1330 controlled by the single power amplifier 1320 is at or below a SAR value of 2 W/kg, which is in compliance with the IEC (International Electrotechnical Commission) SAR requirement in the European Union. In some embodiments, by using a single power amplifier 1320 with a power range from 2 W to 15 W, the electric field within the power transmission range of the antenna 1330 controlled by the single power amplifier 1320 is at or below a SAR value of 0.8 W/kg. In some embodiments, by using a single power amplifier 1320 with a power range from 2 W to 15 W, the electric field within the power transmission range of the antenna 1330 controlled by the single power amplifier 1320 is at or below any level that is regulated by relevant rules or regulations. In some embodiments, the SAR value in a location of the radiation profile of the antenna decreases as the range of the radiation profile increases.

In some embodiments, the radiation profile generated by the antenna controlled by a single power amplifier is defined based on how much usable power is available to a wireless-power receiver when it receives electromagnetic energy from the radiation profile (e.g., rectifies and converts the electromagnetic energy into a usable DC current), and the amount of usable power available to such a wireless-power receivers 155 can be referred to as the effective transmitted power of an electromagnetic signal. In some embodiments, the effective transmitted power of the electromagnetic signal in a predefined radiation profile is at least 0.5 W. In some embodiments, the effective transmitted power of the signal in a predefined radiation profile is greater than 1 W. In some embodiments, the effective transmitted power of the signal in a predefined radiation profile is greater than 2 W. In some embodiments, the effective transmitted power of the signal in a predefined radiation profile is greater than 5 W. In some embodiments, the effective transmitted power of the signal in a predefined radiation profile is less or equal to 4 W.

FIG. 13B is a block diagram of another wireless-power transmitter 1350 (e.g., wireless-power receiver 135) including an RF power transmitter integrated circuit 1360, one or more 1365, one or more antennas 1330, and/or a power amplifier 1320 in accordance with some embodiments. For ease of discussion and illustration, the other wireless-power transmitters 1350 can be an instance of the wireless-power transmitter devices described above in reference to FIGS. 1-13A, and includes one or more additional and/or distinct components, or omits one or more components. In some embodiments, the RFIC 1360 includes a CPU subsystem 1370, an external device control interface, a subsection for DC to power conversion, and analog and digital control interfaces interconnected via an interconnection component, such as a bus or interconnection fabric block 1371. In some embodiments, the CPU subsystem 1370 includes a microprocessor unit (CPU) 1373 with related Read-Only-Memory (ROM) 1372 for device program booting via a digital control interface, e.g., an I2C port, to an external FLASH containing the CPU executable code to be loaded into the CPU Subsystem Random Access Memory (RAM) 1374 (e.g., memory 1406, FIG. 2) or executed directly from FLASH. In some embodiments, the CPU subsystem 1370 also includes an encryption module or block 1376 to authenticate and secure communication exchanges with external devices, such as wireless-power receivers that attempt to receive wirelessly delivered power from the Wireless-power transmitters 135. In some embodiments, the wireless-power transmitters 135 may also include a temperature monitoring circuit (not shown) that is in communication with the CPU subsystem 1370 to ensure that the wireless-power transmitters 135 remains within an acceptable temperature range. For example, if a determination is made that the wireless-power transmitters 135 has reached a threshold temperature, then operation of the wireless-power transmitters 135 may be temporarily suspended until the wireless-power transmitters 135 falls below the threshold temperature.

In some embodiments, the RFIC 1360 also includes (or is in communication with) a power amplifier controller IC (PAIC) 1361A that is responsible for controlling and managing operations of a power amplifier, including, but not limited to, reading measurements of impedance at various measurement points within the power amplifier, instructing the power amplifier to amplify the electromagnetic signal, synchronizing the turn on and/or shutdown of the power amplifier, optimizing performance of the power amplifier, protecting the power amplifier, and other functions discussed herein. In some embodiments, the impedance measurement are used to allow the wireless-power transmitters 135 (via the RFIC 1360 and/or PAIC 1361A) to detect of one or more foreign objects, optimize operation of the one or more power amplifiers, assess one or more safety thresholds, detect changes in the impedance at the one or more power amplifiers, detect movement of the receiver within the wireless transmission field, protect the power amplifier from damage (e.g., by shutting down the power amplifier, changing a selected power level of the power amplifier, and/or changing other configurations of the wireless-power transmitters 135), classify a receiver (e.g., authorized receivers, unauthorized receivers, and/or receiver with an object), compensate for the power amplifier (e.g., by making hardware, software, and/or firmware adjustments), tune the wireless-power transmitters 135, and/or other functions.

In some embodiments, the PAIC 1361A may be on the same integrated circuit as the RFIC 1360. Alternatively, in some embodiments, the PAIC 1361A may be on its own integrated circuit that is separate from (but still in communication with) the RFIC 1360. In some embodiments, the PAIC 1361A is on the same chip with one or more of the power amplifiers 1320. In some other embodiments, the PAIC 1361A is on its own chip that is a separate chip from the power amplifiers 1320. In some embodiments, the PAIC 1361A may be on its own integrated circuit that is separate from (but still in communication with) the RFIC 1360 enables older systems to be retrofitted. In some embodiments, the PAIC 1361A as a standalone chip communicatively coupled to the RFIC 1360 can reduce the processing load and potential damage from over-heating. Alternatively or additionally, in some embodiments, it is more efficient to design and use two different ICs (e.g., the RFIC 1360 and the PAIC 1361A).

In some embodiments, executable instructions running on the CPU (such as those shown in the memory 1406 in FIG. 14, and described below) are used to manage operation of the wireless-power transmitters 135 and to control external devices through a control interface, e.g., SPI control interface 1375, and the other analog and digital interfaces included in the RFIC 1360. In some embodiments, the CPU subsystem 1370 also manages operation of the subsection of the RFIC 1360, which includes a local oscillator (LO) 1377 and a transmitter (TX) 1378. In some embodiments, the LO 1377 is adjusted based on instructions from the CPU subsystem 1370 and is thereby set to different desired frequencies of operation, while the TX converts, amplifies, modulates the output as desired to generate a viable power level.

In some embodiments, the RFIC 1360 and/or PAIC 1361A provide the viable power level (e.g., via the TX 1378) directly to the one or more power amplifiers 1320 and does not use any beam-forming capabilities (e.g., bypasses/disables a beam-forming IC and/or any associated algorithms if phase-shifting is not required, such as when only a single antenna 1330 is used to transmit power transmission signals to a wireless-power receiver 155). In some embodiments, by not using beam-forming control, there is no active beam-forming control in the power transmission system. For example, in some embodiments, by eliminating the active beam-forming control, the relative phases of the power signals from different antennas are unaltered after transmission. In some embodiments, by eliminating the active beam-forming control, the phases of the power signals are not controlled and remain in a fixed or initial phase. In some embodiments, the RFIC 1360 and/or PAIC 1361A regulate the functionality of the power amplifiers 1320 including adjusting the viable power level to the power amplifiers 1320, enabling the power amplifiers 1320, disabling the power amplifiers 1320, and/or other functions.

Various arrangements and couplings of power amplifiers 1320 to antenna coverage areas 1390 (which can be instance of the plurality of power-transfer points 202 of an transmitter antenna element 136; FIGS. 1-12D) allow the wireless-power receiver 155 to sequentially or selectively activate different antenna coverage areas 1390 (i.e., power transfer points) in order to determine the most efficient and safest (if any) antenna coverage area 1390 to use for transmitting wireless-power to a wireless-power receiver 155.

In some embodiments, the one or more power amplifiers 1320 are also controlled by the CPU subsystem 1370 to allow the CPU 1373 to measure output power provided by the power amplifiers 1320 to the antenna coverage areas (i.e., plurality of power-transfer points 202) of the wireless-power transmitter 135. In some embodiments, the one or more power amplifiers 1320 are controlled by the CPU subsystem 1370 via the PAIC 1361A. In some embodiments, the power amplifiers 1320 may include various measurement points that allow for at least measuring impedance values that are used to enable the foreign object detection techniques, receiver and/or foreign object movement detection techniques, power amplifier optimization techniques, power amplifier protection techniques, receiver classification techniques, power amplifier impedance detection techniques, and/or other safety techniques described in commonly-owned U.S. patent application Ser. No. 16/932,631, which is incorporated by reference in its entirety for all purposes.

FIG. 14 is a block diagram illustrating one or more components of a wireless-power transmitter 135, in accordance with some embodiments. In some embodiments, the wireless-power transmitter 135 includes an RFIC 1360 (and the components included therein, such as a PAIC 1361A and others described above in reference to FIGS. 13A-13B), memory 1406 (which may be included as part of the RFIC 1360, such as nonvolatile memory 1406 that is part of the CPU subsystem 1370), one or more CPUs 1373, and one or more communication buses 1408 for interconnecting these components (sometimes called a chipset). In some embodiments, the wireless-power transmitter 135 includes one or more sensors 1365. In some embodiments, the wireless-power transmitter 135 includes one or more output devices such as one or more indicator lights, a sound card, a speaker, a small display for displaying textual information and error codes, etc. In some embodiments, the wireless-power transmitter 135 includes a location detection device, such as a GPS other geo-location receiver, for determining the location of the wireless-power transmitter 135.

In some embodiments, the one or more sensors 1365 include one or more capacitive sensors, inductive sensors, ultrasound sensors, photoelectric sensors, time-of-flight sensors (e.g., IR sensors, ultrasonic time-of-flight sensors, phototransistor receiver systems, etc.), thermal radiation sensors, ambient temperature sensors, humidity sensors, IR sensors or IR LED emitter, occupancy sensors (e.g., RFID sensors), ambient light sensors, motion detectors, accelerometers, heat detectors, hall sensors, proximity sensors, sound sensors, pressure detectors, light and/or image sensors, and/or gyroscopes, as well as integrated sensors in one or more antennas.

In some embodiments, the wireless-power transmitter 135 further includes an optional signature-signal receiving circuit 1440, an optional reflected power coupler 1448, and an optional capacitive charging coupler 1450.

The memory 1406 includes high-speed random access memory, such as DRAM, SRAM, DDR SRAM, or other random access solid state memory devices; and, optionally, includes non-volatile memory, such as one or more magnetic disk storage devices, one or more optical disk storage devices, one or more flash memory devices, or one or more other non-volatile solid state storage devices. The memory 1406, or alternatively the non-volatile memory within memory 1406, includes a non-transitory computer-readable storage medium. In some embodiments, the memory 1406, or the non-transitory computer-readable storage medium of the memory 1406, stores the following programs, modules, and data structures, or a subset or superset thereof:
Operating logic 1416 including procedures for handling various basic system services and for performing hardware dependent tasks;
Communication module 1418 for coupling to and/or communicating with remote devices (e.g., remote sensors, transmitters, receivers, servers, mapping memories, etc.) in conjunction with wireless communication component(s) 1310;
Sensor module 1420 for obtaining and processing sensor data (e.g., in conjunction with sensor(s) 1365) to, for example, determine or detect the presence, velocity, and/or positioning of object in the vicinity of the wireless-power transmitter 135 as well as classify a detected object;
Power-wave generating module 1422 for generating and transmitting power transmission signals (e.g., in conjunction with antenna coverage areas 1390 and the antennas 1330 respectively included therein), including but not limited to, forming pocket(s) of energy at given locations, and controlling and/or managing the power amplifier (e.g., by performing one or functions of the PAIC 1361A). Optionally, the power-wave generating module 1422 may also be used to modify values of transmission characteristics (e.g., power level (i.e., amplitude), phase, frequency, etc.) used to transmit power transmission signals by individual antenna coverage areas;
Impedance determining module 1423 for determining an impedance of the power amplifier based on parametric parameters obtained from one or more measurement points within the wireless-power transmitter 135 (e.g., determining an impedance using one or more Smith charts). Impedance determining module 1423 may also be used to determine the presence of a foreign object, classify a receiver, detect changes in impedances, detect movement of a foreign object and/or receiver, determine optimal and/or operational impedances, as well as a number of other functions describe below;
Database 1424, including but not limited to:
   Sensor information 1426 for storing and managing data received, detected, and/or transmitted by one or more sensors (e.g., sensors 1365 and/or one or more remote sensors);
   Device settings 1428 for storing operational settings for the wireless-power transmitter 135 and/or one or more remote devices including, but not limited to, lookup tables (LUT)s for SAR, e-field roll-off, producing a certain radiation profile from among various radiation profiles, Smith Charts, antenna tuning parameters, and/or values associated with parametric parameters of the wireless-power transmitter 135 for different configurations (e.g., obtained during simulation, characterization, and/or manufacture tests of the wireless-power transmitter 135 and/or updated during operation (e.g., learned improvements to the system)). Alternatively, raw values can be stored for future analysis;
   Communication protocol information 1430 for storing and managing protocol information for one or more protocols (e.g., custom or standard wireless protocols, such as ZigBee, Z-Wave, etc. and/or custom or standard wired protocols, such as Ethernet); and
   Optional learned signature signals 1432 for a variety of different wireless-power receivers and other objects (which are not wireless-power receivers).
A secure element module 234 for determining whether a wireless-power receiver is authorized to receive wirelessly delivered power from the wireless-power transmitter 135;
An antenna zone selection and tuning module 1437 for coordinating a process of transmitting test power transmission signals to an antenna 1330 (e.g., antenna element 136) with various antenna coverage areas (i.e., power-transfer points) to determine which antenna coverage area (i.e., power-transfer point) should be used to wirelessly deliver power to various wireless-power receivers as described herein (additional examples and embodiments are provided in reference to FIGS. 9A-9B of PCT Patent Application No. PCT/US2019/015820 (U.S. Pat. No. 10,615,647), which is incorporated by reference in its entirety for all purposes; and also provided in PCT/US2017/065886 (U.S. Pat. No. 10,256,677), which is incorporated by reference in its entirety for all purposes);
An authorized receiver and object detection module 1438 used for detecting various signature signals from wireless-power receivers and from other objects, and then determining appropriate actions based on the detecting of the various signature signals (as is explained in more detail in reference to FIGS. 9A-9B of PCT Patent Application No. PCT/US2019/015820 (U.S. Pat. No. 10,615,647), which is incorporated by reference in its entirety for all purposes; also explained in more detail in PCT/US2017/065886 (U.S. Pat. No. 10,256,677), which is incorporated by reference in its entirety for all purposes); and
An optional signature-signal decoding module 1439 used to decode the detected signature signals and determine message or data content. In some embodiments, the module 1439 includes an electrical measurement module 1442 to collect electrical measurements from one or more receivers (e.g., in response to power beacon signals), a feature vector module 1444 to compute feature vectors based on the electrical measurements collected by the electrical measurement module 1439, and/or machine learning classifier model(s) 1446 that are trained to detect and/or classify foreign objects (additional detail provided in commonly-owned U.S. Patent Publication No. 2019/0245389, which is incorporated by reference herein for all purposes).

Each of the above-identified elements (e.g., modules stored in memory 1406 of the wireless-power transmitter 135) is optionally stored in one or more of the previously mentioned memory devices, and corresponds to a set of instructions for performing the function(s) described above. The above-identified modules or programs (e.g., sets of instructions) need not be implemented as separate software programs, procedures, or modules, and thus various subsets of these modules are optionally combined or otherwise rearranged in various embodiments. In some embodiments, the memory 1406, optionally, stores a subset of the modules and data structures identified above.

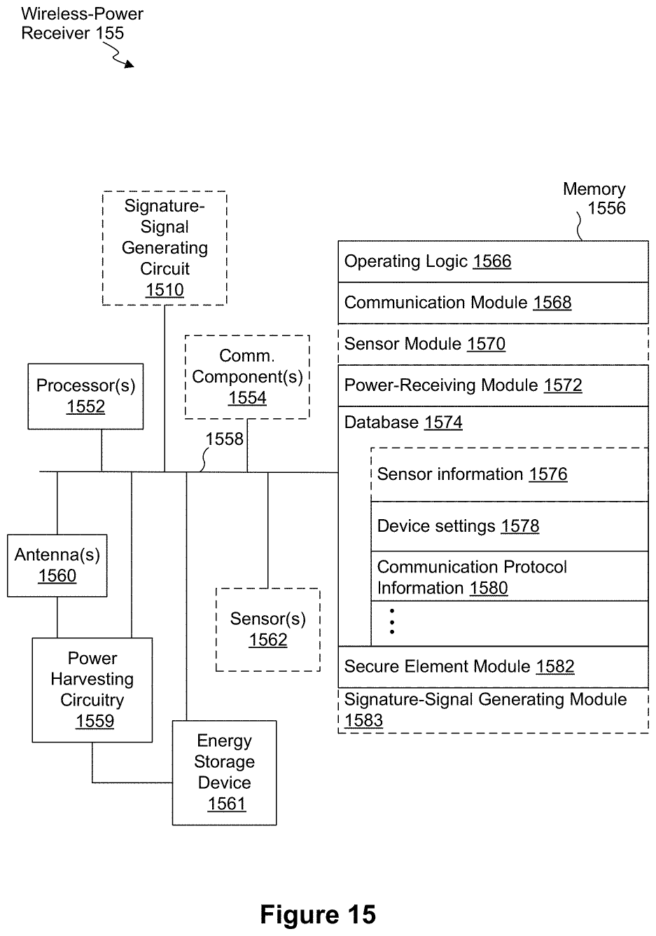

FIG. 15 is a block diagram illustrating a representative wireless-power receiver 155 (also sometimes interchangeably referred to herein as a receiver, or power receiver), in accordance with some embodiments. In some embodiments, the wireless-power receiver 155 includes one or more processing units (e.g., CPUs, ASICs, FPGAs, microprocessors, and the like) 1552, one or more communication components 1554, memory 1556, antenna(s) 1560 (which can be instances receiver antenna elements 302; FIGS. 1-12D), power harvesting circuitry 1559 (e.g., power conversion circuitry 306; FIG. 3), and one or more communication buses 1558 for interconnecting these components (sometimes called a chipset). In some embodiments, the wireless-power receiver 155 includes one or more optional sensors 1562, similar to the one or sensors 11565 described above with reference to FIG. 14. In some embodiments, the wireless-power receiver 155 includes an energy storage device 1561 for storing energy harvested via the power harvesting circuitry 1559. In various embodiments, the energy storage device 1561 includes one or more batteries, one or more capacitors, one or more inductors, and the like.

In some embodiments, the power harvesting circuitry 1559 includes one or more rectifying circuits and/or one or more power converters. In some embodiments, the power harvesting circuitry 1559 includes one or more components (e.g., a power converter) configured to convert energy from power waves and/or energy pockets to electrical energy (e.g., electricity). In some embodiments, the power harvesting circuitry 1559 is further configured to supply power to a coupled electronic device, such as a laptop or phone. In some embodiments, supplying power to a coupled electronic device include translating electrical energy from an AC form to a DC form (e.g., usable by the electronic device).

In some embodiments, the optional signature-signal generating circuit 1510 includes one or more components as discussed with reference to FIGS. 3A-3D of commonly-owned U.S. Patent Publication No. 2019/0245389, which is incorporated by reference in its entirety for all purposes.

In some embodiments, the antenna(s) 1560 include one or more helical antennas, such as those described in detail in commonly-owned U.S. Pat. No. 10,734,717, which is incorporated by reference in its entirety for all purposes (e.g., with particular reference to FIGS. 2-4B, and elsewhere).

In some embodiments, the wireless-power receiver 155 includes one or more output devices such as one or more indicator lights, a sound card, a speaker, a small display for displaying textual information and error codes, etc. In some embodiments, the wireless-power receiver 155 includes a location detection device, such as a GPS (global positioning satellite) or other geo-location receiver, for determining the location of the wireless-power transmitter 155.

In various embodiments, the one or more sensors 1562 include one or more thermal radiation sensors, ambient temperature sensors, humidity sensors, IR sensors, occupancy sensors (e.g., RFID sensors), ambient light sensors, motion detectors, accelerometers, and/or gyroscopes. It is noted that the foreign object detection techniques can operate without relying on the one or more sensor(s) 1562.

The communication component(s) 1554 enable communication between the wireless-power receiver 155 and one or more communication networks. In some embodiments, the communication component(s) 1554 are capable of data communications using any of a variety of custom or standard wireless protocols (e.g., IEEE 802.15.4, Wi-Fi, ZigBee, 6LoWPAN, Thread, Z-Wave, Bluetooth Smart, ISA100.11a, WirelessHART, MiWi, etc.) custom or standard wired protocols (e.g., Ethernet, HomePlug, etc.), and/or any other suitable communication protocol, including communication protocols not yet developed as of the filing date of this document. It is noted that the foreign object detection techniques can operate without relying on the communication component(s) 1554.

The communication component(s) 1554 include, for example, hardware capable of data communications using any of a variety of custom or standard wireless protocols (e.g., IEEE 802.15.4, Wi-Fi, ZigBee, 6LoWPAN, Thread, Z-Wave, Bluetooth Smart, ISA100.11a, WirelessHART, MiWi, etc.) and/or any of a variety of custom or standard wired protocols (e.g., Ethernet, HomePlug, etc.), or any other suitable communication protocol, including communication protocols not yet developed as of the filing date of this document.

The memory 1556 includes high-speed random access memory, such as DRAM, SRAM, DDR SRAM, or other random access solid state memory devices; and, optionally, includes non-volatile memory, such as one or more magnetic disk storage devices, one or more optical disk storage devices, one or more flash memory devices, or one or more other non-volatile solid state storage devices. The memory 1556, or alternatively the non-volatile memory within memory 1556, includes a non-transitory computer-readable storage medium. In some embodiments, the memory 1556, or the non-transitory computer-readable storage medium of the memory 1556, stores the following programs, modules, and data structures, or a subset or superset thereof:
Operating logic 1566 including procedures for handling various basic system services and for performing hardware dependent tasks;
Communication module 1568 for coupling to and/or communicating with remote devices (e.g., remote sensors, transmitters, receivers, servers, mapping memories, etc.) in conjunction with communication component(s) 1554;
Optional sensor module 1570 for obtaining and processing sensor data (e.g., in conjunction with sensor(s) 1562) to, for example, determine the presence, velocity, and/or positioning of the wireless-power receiver 155, a wireless-power transmitter 155, or an object in the vicinity of the wireless-power transmitter 155;
Wireless power-receiving module 1572 for receiving (e.g., in conjunction with antenna(s) 1560 and/or power harvesting circuitry 1559) energy from, capacitively-conveyed electrical signals, power waves, and/or energy pockets; optionally converting (e.g., in conjunction with power harvesting circuitry 1559) the energy (e.g., to direct current); transferring the energy to a coupled electronic device; and optionally storing the energy (e.g., in conjunction with energy storage device 1561);
Database 1574, including but not limited to:
   Sensor information 1576 for storing and managing data received, detected, and/or transmitted by one or more sensors (e.g., sensors 1562 and/or one or more remote sensors);
   Device settings 1578 for storing operational settings for the wireless-power transmitter 155, a coupled electronic device, and/or one or more remote devices; and
   Communication protocol information 1580 for storing and managing protocol information for one or more protocols (e.g., custom or standard wireless protocols, such as ZigBee, Z-Wave, etc. and/or custom or standard wired protocols, such as Ethernet);
A secure element module 1582 for providing identification information to the wireless-power transmitter 135 (e.g., the wireless-power transmitter 135 uses the identification information to determine if the wireless-power receiver 1504 is authorized to receive wirelessly delivered power); and
An optional signature-signal generating module 15815 used to control (in conjunction with the signature-signal generating circuit 1510) various components to cause impedance changes at the antenna(s) 1560 and/or power harvesting circuitry 1559 to then cause changes in reflected power as received by a signature-signal receiving circuit 1440.

Each of the above-identified elements (e.g., modules stored in memory 1556 of the receiver 1504) is optionally stored in one or more of the previously mentioned memory devices, and corresponds to a set of instructions for performing the function(s) described above. The above-identified modules or programs (e.g., sets of instructions) need not be implemented as separate software programs, procedures, or modules, and thus various subsets of these modules are optionally combined or otherwise rearranged in various embodiments. In some embodiments, the memory 1556, optionally, stores a subset of the modules and data structures identified above. Furthermore, the memory 1556, optionally, stores additional modules and data structures not described above, such as an identifying module for identifying a device type of a connected device (e.g., a device type for an electronic device that is coupled with the receiver 1504).

In some embodiments, the near-field power transmitters disclosed herein may use adaptive loading techniques to optimize power transfer. Such techniques are described in detail in commonly-owned and incorporated-by-reference PCT Application No. PCT/US2017/065886 and, in particular, in reference to FIGS. 5-8 and 12-15 of PCT Application No. PCT/US2017/065886.

In some embodiments, the wireless-power transmitter 155 is coupled to or integrated with an election device, such as a pen, a marker, a phone, a tablet, a laptop, a hearing aid, smart glasses, headphones, computer accessories (e.g., mouse, keyboard, remote speakers), and/or other electrical devices. In some embodiments, the wireless-power transmitter 155 is coupled to or integrated with small consumer device, such as a fitness band, a smart watch, and/or other wearable product. Alternatively, in some embodiments, the wireless-power transmitter 155 is an electronic device.

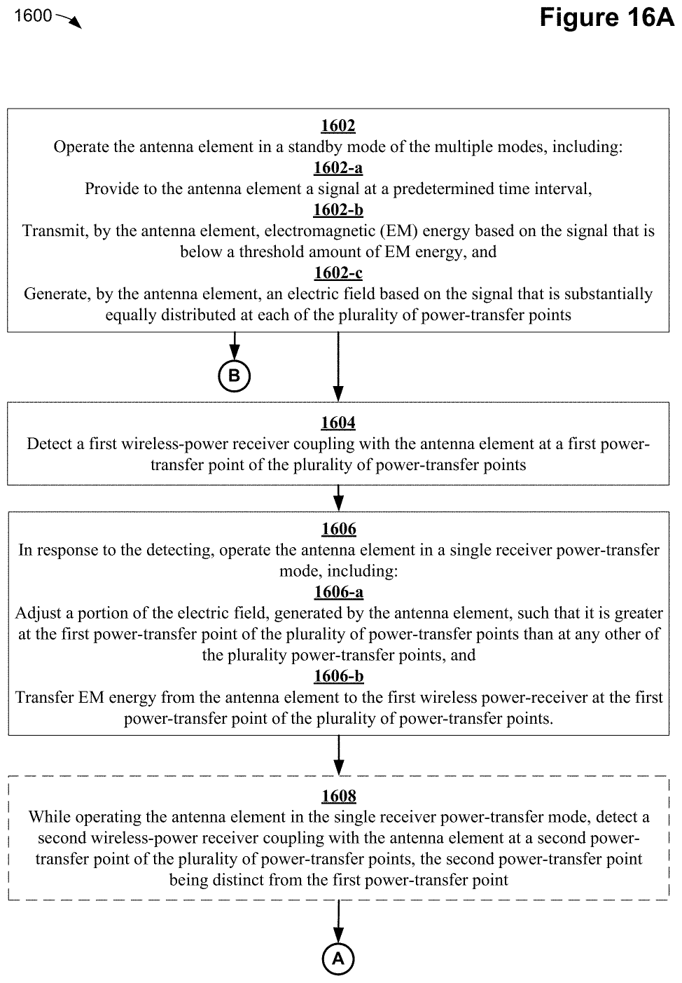

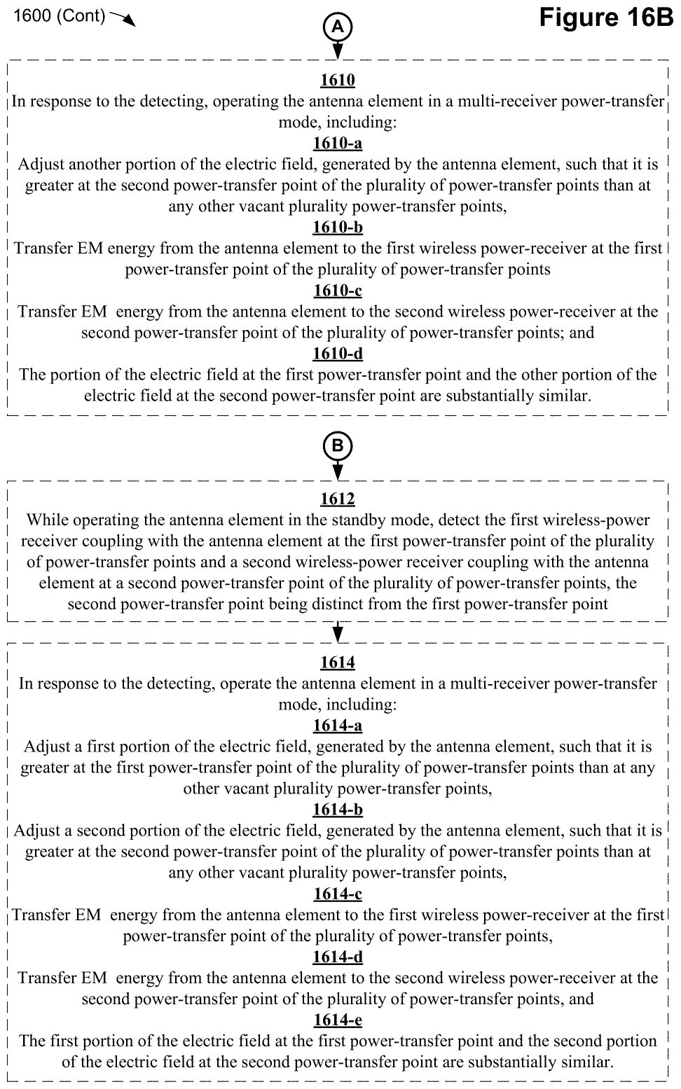

FIGS. 16A-16B are flow diagrams showing a method of transferring electromagnetic energy to one or more wireless-power receivers 155 (FIGS. 3-6C), in accordance with some embodiments. Operations (e.g., steps) of the method 1600 may be performed by a wireless-power transmitter 135 (or one or more integrated circuits of the wireless-power transmitter 135 (e.g., RFIC 160 of the wireless-power transmitter 135, as shown in in at least FIGS. 13A-13B and 14, and/or a PAIC 161A as shown in at least FIG. 13B). At least some of the operations shown in FIGS. 16A-16B correspond to instructions stored in a computer memory or computer-readable storage medium (e.g., memory 1372 and 1374 of the wireless-power transmitter 135, FIG. 13B; memory 1406 of the wireless-power transmitter 135). In some embodiments, some, but not all, of the operations illustrated in FIGS. 16A-16B, are performed. Similarly, one or more operations illustrated in FIGS. 16A-16B may be optional or performed in a different sequence. Furthermore, two or more operations of FIGS. 16A-16B consistent with the present disclosure may be overlapping in time, or almost simultaneously.

The method 1600 can be performed at a wireless-power transmitter 135 including a transmitter antenna element 136 (FIG. 1). The transmitter antenna element 136 includes a plurality of power-transfer points 202 (FIG. 2). The transmitter antenna element 136 is configured to operate in multiple modes including a standby mode and a single receiver power-transfer mode. The method 1600 includes operating (1602) the antenna element in a standby mode of the multiple modes. The standby mode includes providing (1602-a) to the transmitter antenna element 136 a signal at a predetermined time interval, transmitting (1602-b), by the transmitter antenna element 136, electromagnetic (EM) energy based on the signal that is below a threshold amount of EM energy, and generating (1602-c), by the transmitter antenna element 136, an electric field based on the signal that is substantially equally distributed at each of the plurality of power-transfer points 202. The pulse signal is used to detect one or more wireless-power receivers 155 at a power-transfer point of the plurality of power-transfer points 202. When the signal is not provided to the transmitter antenna element 136, the transmitter antenna element 136 does not continuously transmit electromagnetic energy (i.e., generally producing 0 dB or less). Additional examples are provided above in FIGS. 1 and 2A-2B.

The method 1600 includes detecting (1604) a first wireless-power receiver 155 coupling with the transmitter antenna element 136 at a first power-transfer point of the plurality of power-transfer points 202. In response to the detecting, the method 1600 includes operating (1606) the transmitter antenna element 136 in a single receiver power-transfer mode. While in the single receiver power-transfer mode the method 1600 includes adjusting (1606-a) a portion of the electric field, generated by the transmitter antenna element 136, such that it is greater at the first power-transfer point of the plurality of power-transfer points than at any other of the plurality power-transfer point. The method 1600 further includes transferring (1606-b) EM energy from the transmitter antenna element 136 to the first wireless power-receiver 155 at the first power-transfer point of the plurality of power-transfer points 202. Additional examples are provided above in FIGS. 1 and 7A-10B.

In some embodiments, the method 1600 includes, while operating the transmitter antenna element 136 in the single receiver power-transfer mode, detecting (1608) a second wireless-power receiver 155 coupling with the transmitter antenna element 136 at a second power-transfer point of the plurality of power-transfer points 202, the second power-transfer point being distinct from the first power-transfer point. In response to the detecting, the method 1600 includes operating (1610) the transmitter antenna element 136 in a multi-receiver power-transfer mode. While in the multi-receiver power-transfer mode the method 1600 includes adjusting (1610-a) another portion of the electric field, generated by the transmitter antenna element 136, such that it is greater at the second power-transfer point of the plurality of power-transfer points 202 than at any other vacant plurality power-transfer points. The method 1600 further includes transferring (1610-b) EM energy from the transmitter antenna element 136 to the first wireless power-receiver 155 at the first power-transfer point of the plurality of power-transfer points 202, and transferring (1610-c) EM energy from the transmitter antenna element 136 to the second wireless power-receiver 155 at the second power-transfer point of the plurality of power-transfer points 202. The portion of the electric field at the first power-transfer point and the other portion of the electric field at the second power-transfer point are (1610-d) substantially similar. Additional examples are provided above in FIGS. 1 and 11A-12D.

In some embodiments, the method 1600 includes, while operating the transmitter antenna element 136 in the standby mode, detecting (1612) the first wireless-power receiver 155 coupling with the transmitter antenna element 136 at the first power-transfer point of the plurality of power-transfer points 202 and a second wireless-power receiver 155 coupling with the transmitter antenna element 136 at a second power-transfer point of the plurality of power-transfer points 202, the second power-transfer point being distinct from the first power-transfer point. The method 1600 includes, in response to the detecting, operating (1614) the transmitter antenna element 136 in a multi-receiver power-transfer mode. While in the multi-receiver power-transfer mode the method 1600 includes adjusting (1614-a) a first portion of the electric field, generated by the transmitter antenna element 136, such that it is greater at the first power-transfer point of the plurality of power-transfer points 202 than at any other vacant plurality power-transfer points, and adjusting (1614-b) a second portion of the electric field, generated by the transmitter antenna element 136, such that it is greater at the second power-transfer point of the plurality of power-transfer points 202 than at any other vacant plurality power-transfer points. The method 1600 further includes transferring (1614-c) EM energy from the transmitter antenna element 136 to the first wireless power-receiver 155 at the first power-transfer point of the plurality of power-transfer points 202, and transferring (1614-d) EM energy from the transmitter antenna element 136 to the second wireless power-receiver 155 at the second power-transfer point of the plurality of power-transfer points 202. The first portion of the electric field at the first power-transfer point and the second portion of the electric field at the second power-transfer point are (1614-e) substantially similar. Additional examples are provided above in FIGS. 1 and 11A-12D.

In some embodiments, the wireless-power transmitter 135 further includes an E-wall 138 (FIG. 1) surrounding the transmitter antenna element 136, the E-wall 138 configured to modulate the portion of the electric field at the one of the plurality of the power-transfer points 202. In some embodiments, the E-wall 138 provides an extended ground plane. In some embodiments, the E-wall 138 is configured to maximize the power transfer to the one of the plurality of power-transfer points 202. In some embodiments, the E-wall 138 that is configured to direct the portion of the electric field vertically from the transmitter antenna element 136. Additional examples are provided above in FIGS. 1, 8A-8D, and 10A-10B.

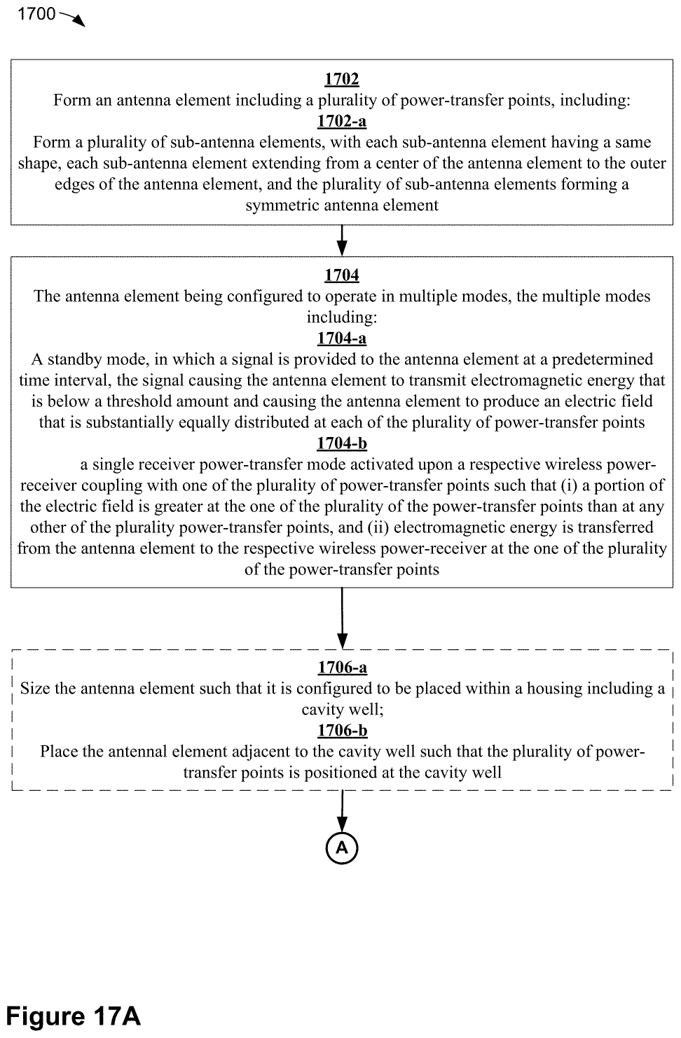

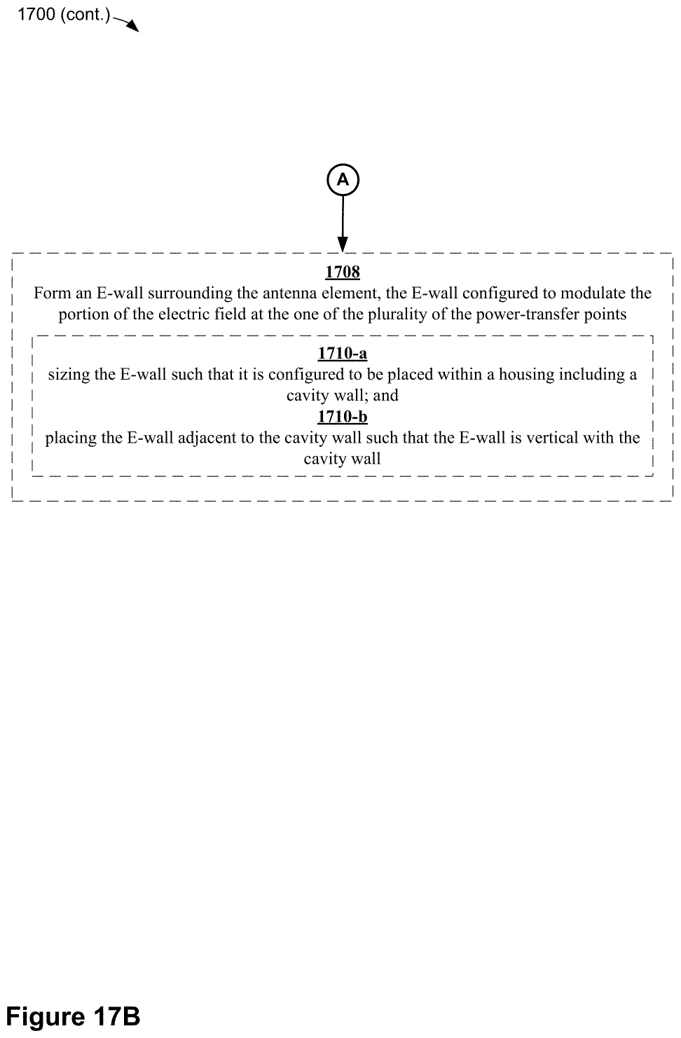

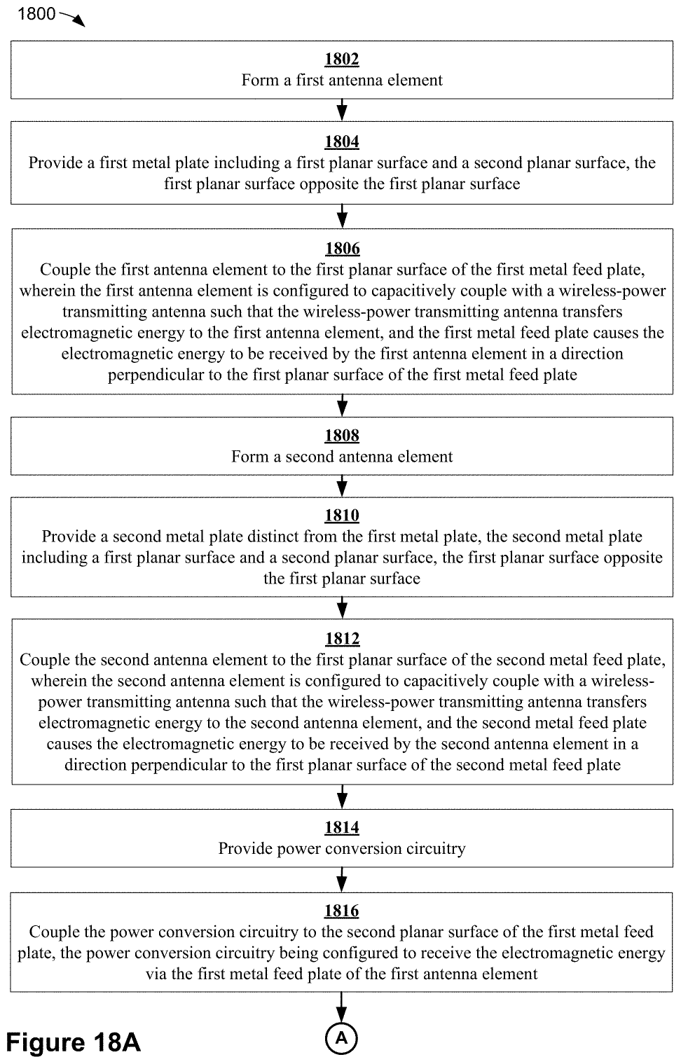

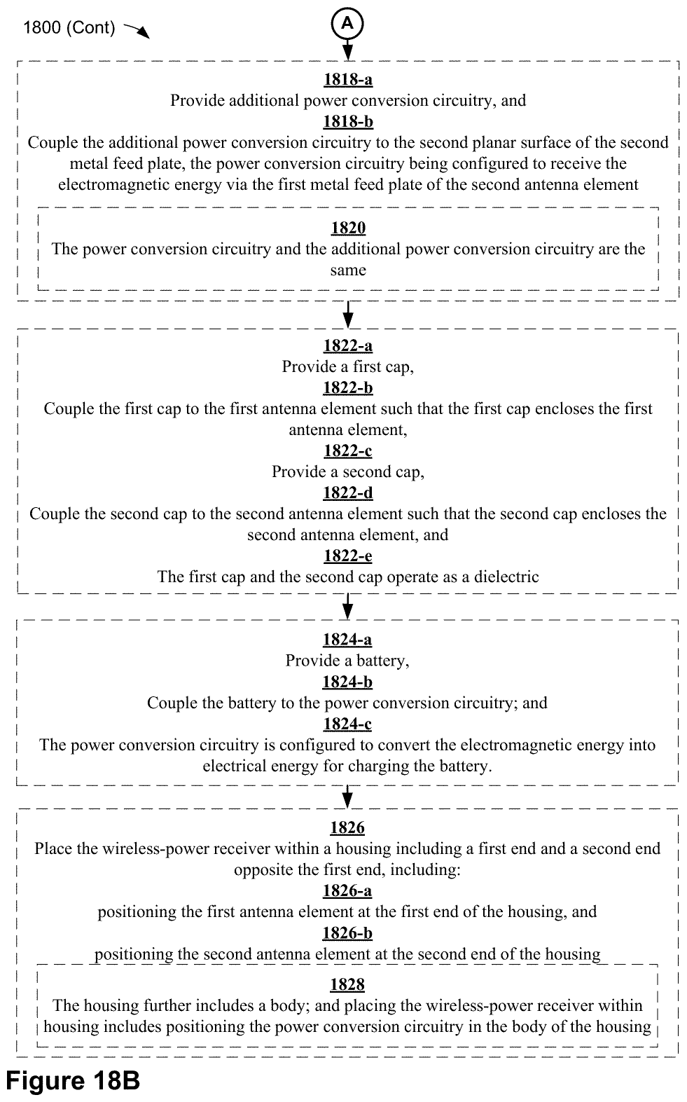

FIGS. 17A-18B are flow diagrams showing a method of forming a wireless-power transmitter 135 and a wireless-power receiver 155, in accordance with some embodiments. In some embodiments, some, but not all, of the operations illustrated in FIGS. 17A-18B, are performed. Similarly, one or more operations illustrated in FIGS. 17A-18B may be optional or performed in a different sequence. Furthermore, two or more operations of FIG. 17A-18B consistent with the present disclosure may be overlapping in time, or almost simultaneously.

In FIGS. 17A and 17B, a method 1700 forming a wireless-power transmitter 135 (FIG. 1) includes forming (1702) a transmitter antenna element 136 including a plurality of power-transfer points 202 (FIG. 2). The forming the transmitter antenna element 136 includes forming (1702-a) a plurality of sub-antenna elements. Each sub-antenna element has a same shape, each sub-antenna element extends from a center of the transmitter antenna element 136 to the outer edges of the transmitter antenna element 136, and the plurality of sub-antenna elements form a symmetric transmitter antenna element 136. Additional examples are provided above in FIGS. 1 and 2A.

The formed transmitter antenna element 136 is configured to operate (1704) in multiple modes. The multiple modes include a standby mode and a single receiver power-transfer mode. In the standby mode (1704-a), a signal is provided to the transmitter antenna element 136 at a predetermined time interval. The signal causes the transmitter antenna element 136 to transmit electromagnetic energy that is below a threshold amount and causes the transmitter antenna element 136 to produce an electric field that is substantially equally distributed at each of the plurality of power-transfer points. The single receiver power-transfer mode (1704-b) is activated upon a respective wireless power-receiver 155 (FIGS. 3-6C) coupling with one of the plurality of power-transfer points 202 such that (i) a portion of the electric field is greater at the one of the plurality of the power-transfer points than at any other of the plurality power-transfer points, and (ii) electromagnetic energy is transferred from the transmitter antenna element 136 to the respective wireless power-receiver 155 at the one of the plurality of the power-transfer points.

In some embodiments, the method 1700 includes positioning the transmitter within a housing (e.g., a housing of transmitter device 130; FIG. 1). In some embodiments, the method 1700 includes sizing (1706-a) the transmitter antenna element 136 that it is configured to be placed within a housing including a cavity well 134 (FIG. 1), and placing (1706-b) the transmitter antenna element 136 adjacent to the cavity well 134 such that the plurality of power-transfer points 202 is positioned at the cavity well 124. In some embodiments, the method 1700 includes forming (1708) an E-wall 138 (FIG. 1) surrounding the transmitter antenna element 136. The E-wall 138 is configured to modulate the portion of the electric field at the one of the plurality of the power-transfer points. In some embodiments, the E-wall 138 is configured to provide an extended ground plane. In some embodiments, the E-wall 138 is configured to maximize the power transfer to the one of the plurality of power-transfer points. In some embodiments, the E-wall is configured to direct the portion of the electric field vertically from the transmitter antenna element 136. In some embodiments, the method 1700 includes sizing (1710-a) the E-wall 138 such that it is configured to be placed within a housing including a cavity wall 132 (FIG. 1), and placing (1710-b) the E-wall 138 adjacent to the cavity wall 132 such that the E-wall 138 is vertical with the cavity wall 132. Additional examples are provided above in FIGS. 1 and 2A.

In FIGS. 18A and 18B, a method 1800 of forming a wireless-power receiver 155 (FIGS. 1 and 3-6C) includes forming (1802) a first receiver antenna element 302 (FIG. 3), providing (1804) a first metal plate 304 including a first planar surface and a second planar surface, the first planar surface opposite the first planar surface, and coupling (1806) the first receiver antenna element 302 to the first planar surface of the first metal feed plate 304. The first receiver antenna element 302 is configured to capacitively couple with a wireless-power transmitting antenna (e.g., transmitter antenna element 136; FIG. 1) such that the wireless-power transmitting antenna transfers electromagnetic energy to the first receiver antenna element 302. The first metal feed plate 304 causes the electromagnetic energy to be received by the first receiver antenna element 302 in a direction perpendicular to the first planar surface of the first metal feed plate 304. The method 1800 further includes forming (1808) a second receiver antenna element 302, providing (1810) a second metal plate distinct from the first metal plate, the second metal plate including a first planar surface and a second planar surface, the first planar surface opposite the first planar surface, and coupling (1812) the second receiver antenna element 302 to the first planar surface of the second metal feed plate 304. The second receiver antenna element 302 is configured to capacitively couple with a wireless-power transmitting antenna such that the wireless-power transmitting antenna transfers electromagnetic energy to the second receiver antenna element 302. The second metal feed plate 304 causes the electromagnetic energy to be received by the second receiver antenna element 302 in a direction perpendicular to the first planar surface of the second metal feed plate 304. Additional examples are provided above in FIGS. 3-6C.

In some embodiments, the first receiver antenna element 302 and the second receiver antenna element 302 are respective wires forming helical patterns. In some embodiments, the first receiver antenna element 302 is perpendicular to the first planar surface of the first metal feed plate 304 and the second receiver antenna element 302 is perpendicular to the first planar surface of the second metal feed plate 304.

In some embodiments, the method 1800 includes providing (1814) power conversion circuitry 306, and coupling (1816) the power conversion circuitry 306 to the second planar surface of the first metal feed plate 304. The power conversion circuitry 306 is configured to receive the electromagnetic energy via the first metal feed plate 304 of the first receiver antenna element 302. As discussed below, the power conversion circuitry 306 is configured to convert the receive the electromagnetic energy into electrical energy. In some embodiments, the method 1800 includes providing (1818-a) additional power conversion circuitry 306, and coupling (1818-b) the additional power conversion circuitry 306 to the second planar surface of the second metal feed plate 304. The power conversion circuitry 306 is configured to receive the electromagnetic energy via the first metal feed plate 304 of the second receiver antenna element 302. In some embodiments, the power conversion circuitry 306 and the additional power conversion circuitry 306 are (1820) the same.

In some embodiments, the method 1800 includes providing (1822-a) a first cap 308 and coupling (1822-b) the first cap 308 to the first receiver antenna element 302 such that the first cap 308 encloses the first receiver antenna element 302. The method 1800 further includes providing (1822-c) a second cap 308 and coupling (1822-d) the second cap 308 to the second receiver antenna element 302 such that the second cap 308 encloses the second receiver antenna element 302. The first cap 308 and the second cap 308 operate (1822-e) as a dielectrics. In some embodiments, the first and second cap 308 include metallic interiors. Alternatively, in some embodiments, the first and second cap 308 include non-metallic interiors. Additional examples are provided above in FIGS. 5A-6C.

In some embodiments, the method 1800 includes providing (1824-a) a battery and coupling (1824-b) the battery to the power conversion circuitry. The power conversion circuitry 306 is configured (1824-c) to convert the electromagnetic energy into electrical energy for charging the battery. In some embodiments, the convert the electromagnetic energy is used to power an electronic device 150 (FIG. 1).

In some embodiments, the method 1800 includes placing (1826) the wireless-power receiver within a housing including a first end and a second end opposite the first end. The method 1800 further includes positioning (1826-a) the first receiver antenna element 302 at the first end of the housing, and positioning (1826-b) the second receiver antenna element 302 at the second end of the housing. In some embodiments, the housing further includes a body; and placing (1828) the wireless-power receiver within housing further includes positioning the power conversion circuitry 306 in the body of the housing. Additional examples are provided in FIG. 3.

Further embodiments also include various subsets of the above embodiments including embodiments in FIGS. 1-18B combined or otherwise re-arranged in various embodiments.

### Safety Techniques

Any of the various systems and methods described herein can also be configured to utility a variety of additional safety techniques. For instance, a transmitter device can determine the present SAR value of electromagnetic energy at one or more particular locations of the transmission field using one or more sampling or measurement techniques. In some embodiments, the SAR values within the transmission field are measured and pre-determined by SAR value measurement equipment. In some embodiments, a memory associated with the transmitter device may be preloaded with values, tables, and/or algorithms that indicate for the transmitter device which distance ranges in the transmission field are likely to exceed to a pre-stored SAR threshold value. For example, a lookup table may indicate that the SAR value for a volume of space (V) located some distance (D) from the transmitter receiving a number of power waves (P) having a particular frequency (F). One skilled in the art, upon reading the present disclosure, will appreciate that there are any number of potential calculations, which may use any number of variables, to determine the SAR value of electromagnetic energy at a particular locations, each of which is within the scope of this disclosure.

Moreover, a transmitter device may apply the SAR values identified for particular locations in various ways when generating, transmitting, or adjusting the radiation profile. A SAR value at or below 1.6 W/kg, is in compliance with the FCC (Federal Communications Commission) SAR requirement in the United States. A SAR value at or below 2 W/kg is in compliance with the IEC (International Electrotechnical Commission) SAR requirement in the European Union. In some embodiments, the SAR values may be measured and used by the transmitter to maintain a constant energy level throughout the transmission field, where the energy level is both safely below a SAR threshold value but still contains enough electromagnetic energy for the receivers to effectively convert into electrical power that is sufficient to power an associated device, and/or charge a battery. In some embodiments, the transmitter device can proactively modulate the radiation profiles based upon the energy expected to result from newly formed radiation profiles based upon the predetermined SAR threshold values. For example, after determining how to generate or adjust the radiation profiles, but prior to actually transmitting the power, the transmitter device can determine whether the radiation profiles to be generated will result in electromagnetic energy accumulation at a particular location that either satisfies or fails the SAR threshold. Additionally or alternatively, in some embodiments, the transmitter device can actively monitor the transmission field to reactively adjust power waves transmitted to or through a particular location when the transmitter device determines that the power waves passing through or accumulating at the particular location fail the SAR threshold. Where the transmitter device is configured to proactively and reactively adjust the power radiation profile, with the goal of maintaining a continuous power level throughout the transmission field, the transmitter device may be configured to proactively adjust the power radiation profile to be transmitted to a particular location to be certain the power waves will satisfy the SAR threshold, but may also continuously poll the SAR values at locations throughout the transmission field (e.g., using one or more sensors configured to measure such SAR values) to determine whether the SAR values for power waves accumulating at or passing through particular locations unexpectedly fail the SAR threshold.

In some embodiments, control systems of transmitter devices adhere to electromagnetic field (EMF) exposure protection standards for human subjects. Maximum exposure limits are defined by US and European standards in terms of power density limits and electric field limits (as well as magnetic field limits). These include, for example, limits established by the Federal Communications Commission (FCC) for MPE, and limits established by European regulators for radiation exposure. Limits established by the FCC for MPE are codified at 47 CFR § 1.1310. For electromagnetic field (EMF) frequencies in the microwave range, power density can be used to express an intensity of exposure. Power density is defined as power per unit area. For example, power density can be commonly expressed in terms of watts per square meter (W/m²), milliwatts per square centimeter (mW/cm²), or microwatts per square centimeter (μW/cm²).

In some embodiments, and as a non-limiting example, the wireless-power transmission systems disclosed herein comply with FCC Part § 18.107 requirement which specifies “Industrial, scientific, and medical (ISM) equipment. Equipment or appliances designed to generate and use locally electromagnetic energy for industrial, scientific, medical, domestic or similar purposes, excluding applications in the field of telecommunication. In some embodiments, the wireless-power transmission systems disclosed herein comply with ITU (International Telecommunication Union) Radio Regulations which specifies “industrial, scientific and medical (ISM) applications (of radio frequency energy): Operation of equipment or appliances designed to generate and use locally radio frequency energy for industrial, scientific, medical, domestic or similar purposes, excluding applications in the field of telecommunications. In some embodiments, the wireless-power transmission systems disclosed herein comply with other requirements such as requirements codified under EN 62311: 2008, IEC/EN 662209-2: 2010, and IEC/EN 62479: 2010.

In some embodiments, the present systems and methods for wireless-power transmission incorporate various safety techniques to ensure that human occupants in or near a transmission field are not exposed to EMF energy near or above regulatory limits or other nominal limits. One safety method is to include a margin of error (e.g., about 10% to 20%) beyond the nominal limits, so that human subjects are not exposed to power levels at or near the EMF exposure limits. A second safety method can provide staged protection measures, such as reduction or termination of wireless-power transmission if humans (and in some embodiments, other living beings or sensitive objects) move toward a radiation area with power density levels exceeding EMF exposure limits. In some embodiments, these safety methods (and others) are programmed into a memory of the transmitter device (e.g., memory 1406) to allow the transmitter to execute such programs and implement these safety methods.

The preceding description of the disclosed embodiments is provided to enable any person skilled in the art to make or use the embodiments described herein and variations thereof. Various modifications to these embodiments will be readily apparent to those skilled in the art, and the generic principles defined herein may be applied to other embodiments without departing from the spirit or scope of the subject matter disclosed herein. Thus, the present disclosure is not intended to be limited to the embodiments shown herein but is to be accorded the widest scope consistent with the following claims and the principles and novel features disclosed herein.

Features of the present invention can be implemented in, using, or with the assistance of a computer program product, such as a storage medium (media) or computer readable storage medium (media) having instructions stored thereon/in which can be used to program a processing system to perform any of the features presented herein. The storage medium (e.g., memory 1406, 1556) can include, but is not limited to, high-speed random access memory, such as DRAM, SRAM, DDR RAM or other random access solid state memory devices, and may include non-volatile memory, such as one or more magnetic disk storage devices, optical disk storage devices, flash memory devices, or other non-volatile solid state storage devices. Memory optionally includes one or more storage devices remotely located from the CPU(s) (e.g., processor(s)). Memory, or alternatively the non-volatile memory device(s) within the memory, comprises a non-transitory computer readable storage medium.

Stored on any one of the machine readable medium (media), features of the present invention can be incorporated in software and/or firmware for controlling the hardware of a processing system (such as the components associated with the wireless-power transmitter 135 and/or wireless-power receivers 155), and for enabling a processing system to interact with other mechanisms utilizing the results of the present invention. Such software or firmware may include, but is not limited to, application code, device drivers, operating systems, and execution environments/containers.

It will be understood that, although the terms “first,” “second,” etc. may be used herein to describe various elements, these elements should not be limited by these terms. These terms are only used to distinguish one element from another.

The terminology used herein is for the purpose of describing particular embodiments only and is not intended to be limiting of the claims. As used in the description of the embodiments and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

The foregoing description, for purpose of explanation, has been described with reference to specific embodiments. However, the illustrative discussions above are not intended to be exhaustive or to limit the claims to the precise forms disclosed. Many modifications and variations are possible in view of the above teachings. The embodiments were chosen and described in order to best explain principles of operation and practical applications, to thereby enable others skilled in the art.

What is claimed is:

1. A wireless-power transmitter comprising:
an antenna element including a plurality of power-transfer points, wherein the antenna element is configured to operate in multiple modes, the multiple modes including:
a standby mode, in which a signal is provided to the antenna element at a predetermined time interval, the signal causing the antenna element to transmit electromagnetic (EM) energy that is below a threshold amount of EM energy and causing the antenna element to produce an electric field that is substantially equally distributed at each of the plurality of power-transfer points;
a single receiver power-transfer mode activated upon a respective wireless power-receiver coupling with the antenna element at one of the plurality of power-transfer points such that (i) a portion of the electric field is greater at the one of the plurality of the power-transfer points than at any other of the plurality power-transfer points, and (ii) EM energy is transferred from the antenna element to the respective wireless power-receiver at the one of the plurality of the power-transfer points.

2. The wireless-power transmitter of claim 1, wherein the multiple modes further include:
a multi receiver power-transfer mode activated upon at least a first wireless power-receiver coupling with the antenna element at a first power-transfer point of the plurality of power-transfer points, and a second wireless power-receiver coupling with the antenna element at a second power-transfer point of the plurality of power-transfer points distinct from the power-transfer point, wherein:
(i) a first portion of the electric field is greater at the first power-transfer point of the plurality of power-transfer points than at any other vacant power-transfer point of the plurality power-transfer points, and (ii) EM energy is transferred from the antenna element to the first wireless power-receiver at the first power-transfer point of the plurality of power-transfer points;
(iii) a second portion of the electric field is greater at the second power-transfer point of the plurality of power-transfer points than at any other vacant power-transfer point of the plurality power-transfer points, and (iv) EM energy is transferred from the antenna element to the second wireless power-receiver at the second power-transfer point of the plurality of power-transfer points; and
wherein the first portion of the electric field and the second portion of the electric field are substantially similar.

3. The wireless-power transmitter of claim 2, wherein the multi receiver power-transfer mode transfers EM energy from the antenna element to the first wireless power-receiver and the second wireless power-receiver without using a power splitter.

4. The wireless-power transmitter of claim 1, wherein the antenna element has a substantially symmetric design.

5. The wireless-power transmitter of claim 1, wherein the antenna element has a star pattern with a plurality of sub-antenna elements on the edges of the antenna element.

6. The wireless-power transmitter of claim 1, wherein the antenna element includes a plurality of sub-antenna elements, wherein each sub-antenna element includes a sleeve configured to impedance match with a wireless-power receiver.

7. The wireless-power transmitter of claim 1, wherein the antenna element is surrounded by an E-wall that is configured to modulate the portion of the electric field at the one of the plurality of the power-transfer points.

8. The wireless-power transmitter of claim 1, wherein the antenna element is surrounded by an E-wall that provides an extended ground plane.

9. The wireless-power transmitter of claim 1, wherein the antenna element is surrounded by an E-wall that is configured to maximize the power transfer to the one of the plurality of power-transfer points.

10. The wireless-power transmitter of claim 1, wherein the antenna element is surrounded by an E-wall that is configured to direct the portion of the electric field vertically from the antenna element.

11. The wireless-power transmitter of claim 1, wherein the antenna element is surrounded by an E-wall, and the antenna element and the E-wall is sized such that it is configured to be placed within a housing including a cavity well and a cavity wall, wherein the plurality of power-transfer points is positioned at the cavity well, and the E-wall is positioned at the cavity wall.

12. The wireless-power transmitter of claim 1, wherein the antenna element is a low gain antenna element configured to operate at a center frequency of approximately 900 MHz.

13. The wireless-power transmitter of claim 1, wherein while the wireless-power transmitter is in the standby mode, the antenna element has a gain below 3 dBi when the signal is provided to the antenna element.

14. The wireless-power transmitter of claim 1, wherein while the wireless-power transmitter is in the standby mode, the antenna element has a gain below 2 dBi when the signal is provided to the antenna element.

15. The wireless-power transmitter of claim 1, wherein while the wireless-power transmitter is in the single receiver power-transfer mode, the antenna element has a gain of approximately 2 dBi and operates at a center frequency of approximately 900 MHz.

16. The wireless-power transmitter of claim 1, wherein while the wireless-power transmitter is in the single receiver power-transfer mode, the antenna element couples with the respective wireless-power receiver at a coupling efficiency of at least 50%.

17. The wireless-power transmitter of claim 1, wherein while the wireless-power transmitter is in the multi receiver power-transfer mode, the antenna element has a gain of approximately 2 dBi and operates at a center frequency of approximately 900 MHz.

18. The wireless-power transmitter of claim 1, wherein while the wireless-power transmitter is in the multi-receiver power-transfer mode, the antenna element couples with the first and second wireless-power receivers at a combined coupling efficiency of at least 50%.

19. A wireless-power receiver comprising:
a first antenna element coupled to a first planar surface of a first metal feed plate, wherein the first antenna element is configured to capacitively couple with a wireless-power transmitting antenna such that the wireless-power transmitting antenna transfers electromagnetic (EM) energy to the first antenna element, and the first metal feed plate causes the EM energy to be received by the first antenna element in a direction perpendicular to the first planar surface of the first metal feed plate;
a second antenna element coupled to a first planar surface of a second metal feed plate, wherein the second antenna element is configured to capacitively couple with the wireless-power transmitting antenna such that the wireless-power transmitting antenna transfers EM energy to the second antenna element, and the second metal feed plate causes the EM energy to be received by the second antenna element in a direction perpendicular to the first planar surface of the second metal feed plate; and
power conversion circuitry coupled to a second planar surface of the first metal feed plate opposite the first planar surface, the power conversion circuitry being configured to receive the EM energy via the first metal feed plate of the first antenna element.

20. A method of wirelessly providing power comprising:
at a wireless-power transmitter comprising an antenna element including a plurality of power-transfer points, the antenna element configured to operate in multiple modes:
operating the antenna element in a standby mode of the multiple modes, including:
providing to the antenna element a signal at a predetermined time interval,
transmitting, by the antenna element, electromagnetic (EM) energy based on the signal that is below a threshold amount of EM energy, and
generating, by the antenna element, an electric field based on the signal that is substantially equally distributed at each of the plurality of power-transfer points,
detecting a first wireless-power receiver coupling with the antenna element at a first power-transfer point of the plurality of power-transfer points; and
in response to the detecting, operating the antenna element in a single receiver power-transfer mode, including:
adjusting a portion of the electric field, generated by the antenna element, such that it is greater at the first power-transfer point of the plurality of power-transfer points than at any other of the plurality power-transfer points, and
transferring EM energy from the antenna element to the first wireless power-receiver at the first power-transfer point of the plurality of power-transfer points.
